(19) United States
(12) Patent Application Publication
(10) Pub. No.: US 2024/0326651 A1
(43) Pub. Date: Oct. 3, 2024

(54) SYSTEM AND METHOD FOR THERMAL MANAGEMENT OF AN INDUCTIVE WIRELESS POWER CHARGER

(71) Applicant: InductEV, Inc., King of Prussia, PA (US)

(72) Inventors: Andrew W. Daga, Malvern, PA (US); Francis J. McMahon, Malvern, PA (US); Darren A. Campo, Downingtown, PA (US); Christopher E. Williams, Pottstown, PA (US); Matthew L. Ward, Exton, PA (US)

(73) Assignee: InductEV, Inc., King of Prussia, PA (US)

(21) Appl. No.: 18/128,763

(22) Filed: Mar. 30, 2023

(51) Int. Cl. B60L 58/26; B60L 53/12

(52) U.S. Cl. CPC B60L 58/26; B60L 53/12

(57) ABSTRACT

A system and method for managing temperature internal to a Wireless Power Transfer (WPT) system for electric vehicles is provided. The thermal management system of the WPT system uses one or more of passive, semi-active, and active cooling approaches to manage the internal temperatures of the WPT system during a charging session. Improvements in thermal management allow for longer duration charging sessions and higher power charging sessions without the need to suspend charging for cool-down. Further, several different approaches to disguising and implementing the thermal management system in public spaces is also provided.

### FIELD OF INVENTION

The present disclosure relates generally to wireless power transfer, and more specifically, to devices, systems, and methods for providing thermal management of the ground-side charging subsystem of inductive wireless power transfer systems that wirelessly transfer power to remote systems such as vehicles including batteries.

### BACKGROUND

Any transformer (e.g., step-up, step-down, low-frequency, high-frequency, common core, open-core) in operation generates heat from internal conductor impedance and from eddy currents created by the magnetic field interacting with conductive materials within the transformer housing. Techniques for cooling high-power transformers include convective cooling, forced air cooling, liquid coolant baths, and circulated liquid coolant cooling, which are dependent on the amount of heat to be dissipated.

Wireless Power Transfer (“WPT”) systems commonly use inductive coupling between the primary and secondary of an open core transformer to transfer power. Open core (also known as air-core) transformers include a core comprised of high magnetic permeability material (e.g. ferrite). Both wired and wireless power transfer (WPT) systems, commonly used for electric vehicle (EV) charging, require cooling when transferring at high power as both contain heat generating ancillary electronics for voltage level conversion (transformers), rectifiers, and inverters.

EV chargers are sized for expected usage under certain ambient temperature ranges. Thus, as the usage increases above the maximum expected and/or under unexpected temperatures, cooling or heating of the electronics systems may become insufficient and charging service suspended until the electronics are sufficiently cooled or heated to restart or resume service.

### SUMMARY

Various examples are now described to introduce a selection of concepts in a simplified form that are further described below in the Detailed Description. The Summary is not intended to be used to limit the scope of the claimed subject matter.

A system and method are described for managing temperature internal to the coil assembly of a Wireless Power Transfer (WPT) system that uses a single low pressure loop liquid coolant arrangement that uses heat exchange materials internally, selected and shaped to function in a high-intensity magnetic field at low weight, high strength, with ease of manufacturability, and lower component cost. Improvements in thermal management allow for longer duration charging sessions and higher power charging sessions without the need to suspend charging for cool-down.

Use of passive heat exchange elements in heat generating devices such as wireless power transfer (WPT) systems may be seasonal, diurnal or nocturnal, and/or based on ambient temperature. Some semi-active embodiments of passive elements can include fans or pumps to selectively assist in cooling, as needed. In sample configurations, passive (e.g., absorptive, conductive, radiative, convection) heat exchange elements can be installed on the ‘hot’ side of the WPT system where temperature of the coolant is unconstrained and where the heat exchange elements are unreachable by people. This first set of passive elements serves to pre-cool the coolant prior to the active heat exchange. These first passive elements may be valved and the use controlled by the controller. A second set of passive heat exchange elements can be installed on the cool side (between the active heat exchanger and the ground charger). These second passive elements are valved and the use controlled by the controller to take advantage of temperature differentials between the ambient, the passive heat exchange elements, and the minimum temperature of the desired coolant flow.

According to one aspect of the disclosure, a thermal management system for a wireless power transfer (WPT) system for charging electric vehicles with a ground based wireless charger is provided. The thermal management system can include a heat exchanger system thermally coupled to the wireless charger of the WPT system. The heat exchanger system can include a first passive heat exchange element and at least one of a second passive heat exchange element, a semi-active heat exchange element, or an active heat exchange element. The heat exchanger system removes heat from the wireless charger during operation of the wireless charger to maintain a temperature by using the first passive heat exchange element. When the first passive heat exchange element is not sufficient to maintain the temperature of the wireless charger below a predefined temperature limit, to selectively use the second passive heat exchange element, semi-active heat exchange element, or the active heat exchange element.

In some embodiments, the heat exchanger system is fluidly coupled to the wireless charger.

In some embodiments, the heat exchanger system is fluidly coupled to the wireless charger using a liquid coolant.

In some embodiments, the heat exchanger system is thermally coupled to the wireless charger using a gaseous coolant.

In some embodiments, the heat exchanger system uses the semi-active heat exchange element when the first passive heat exchange element is not sufficient to maintain the temperature of the wireless charger below the predefined temperature limit.

In some embodiments, the heat exchanger system uses the active heat exchange element when the semi-active heat exchange element is not sufficient to maintain the temperature of the wireless charger below the predefined temperature limit.

In some embodiments, the first passive heat exchange element does not require the application of external power to produce a cooling effect of the wireless charger.

In some embodiments, the first passive heat exchange element removes heat from the wireless charger and transfers the heat to ambient air.

In some embodiments, the semi-active heat exchange element includes a fan or a pump that selectively assists in cooling the wireless charger by selectively inducing a flow of coolant to remove heat from the wireless charger to maintain the temperature of the wireless charger below the predefined temperature limit.

In some embodiments, the active heat exchange element includes at least one pump, fan, or chiller that continuously operates to produce a continuous flow of coolant past or through the wireless charger to assist in cooling the wireless charger and maintaining the temperature of the wireless charger below the predefined temperature limit.

In some embodiments, the first passive heat exchange element comprises a cold plate disposed under or within the wireless charger of the WPT system, the cold plate comprising parallel bundles of Litz wire that are insulated and stranded together into groups that are cabled in a geometric pattern and extended into earth beneath and around the wireless charger to remove heat from the wireless charger, wherein the Litz wire does not produce eddy currents.

According to another aspect of the disclosure, a thermal management system for a wireless power transfer (WPT) system for charging electric vehicles with a ground based wireless charger is provided. The thermal management system can include a heat exchanger system concealed from public view within a structure. The heat exchanger system can be thermally coupled to the wireless charger of the WPT system. The heat exchanger system comprises one or more of a passive heat exchange element, a semi-active heat exchange element, and an active heat exchange element. The concealed heat exchanger system removes heat from the wireless charger during operation of the wireless charger by using one or more of the passive heat exchange element, the semi-active heat exchange element, and the active heat exchange element to maintain the temperature of the wireless charger below a predefined temperature limit.

In some embodiments, the heat exchanger system is concealed from public view within one or more of a light post heat exchanger and a bollard heat exchanger positioned proximate the wireless charger of the WPT system.

In some embodiments, the heat exchanger system is concealed from public view within a roadway adjacent a bus stop, and an outgoing coolant pipe provides heated coolant from the wireless charger to one or more of a bus stop shelter, a bench within the bus stop shelter, and a sidewalk adjacent the bus stop to heat the bus stop shelter, the bench within the bus stop shelter, or the sidewalk adjacent the bus stop.

In some embodiments, the passive heat exchange element can include a heat pipe having a first end and a second end, the first end of the heat pipe being thermally and mechanically coupled to the wireless charger and the second end of the heat pipe being thermally and mechanically coupled to a curb radiator positioned within a curb adjacent a road surface for transferring heat from the wireless charger to the ambient air through the curb radiator.

In some embodiments, the heat exchanger system is concealed within a loading dock including a loading platform and at least one of an incoming coolant pipe or an outgoing coolant pipe extending along a wall of the loading platform. The loading dock concealed heat exchanger system is configured to remove heat from the wireless charger positioned within a drivable surface of the loading dock. The loading dock concealed heat exchanger system further comprises a passive cooling pad disposed between wheels of the electric vehicle when parked at the loading dock. The passive cooling pad can be configured to transfer heat generated by the wireless charger to one or more of the air and the ground.

According to yet another aspect of the disclosure, a thermal management system for a wireless power transfer (WPT) system for charging electric vehicles with a ground based wireless charger is provided. The thermal management system can include a heat exchanger system thermally coupled to the wireless charger of the WPT system. The heat exchanger system can include one or more of a passive heat exchange element, a semi-active heat exchange element, and an active heat exchange element. The heat exchanger system removes heat from the wireless charger during operation of the wireless charger by using the one or more of the passive heat exchange element, the semi-active heat exchange element, and the active heat exchange element to maintain the temperature of the wireless charger below a predefined temperature limit. The heat removed from the wireless charger of the WPT system is utilized to add heat to a fluid or substance separate from the thermal management system.

In some embodiments, a heat reuse system of a building is positioned adjacent the WPT system, and the thermal management system provides heated coolant from the heat exchanger system to the heat reuse system of the building to heat a fluid for use within the building.

In some embodiments, the heat reuse system receives the heated fluid coolant from an incoming coolant pipe fluidly coupling to the heat reuse system of the building to the thermal management system of the WPT system.

In some embodiments, the heat exchanger system can include a contact heat exchanger side mounted to collocated piping for transferring heat from the wireless charger to one or more of drinking water, sewage, and high-pressure fire-fighting water within the collocated piping.

This summary section is provided to introduce aspects of the inventive subject matter in a simplified form, with further explanation of the inventive subject matter following in the text of the detailed description. The particular combination and order of elements listed in this summary section is not intended to provide limitation to the elements of the claimed subject matter. Rather, it will be understood that this section provides summarized examples of some of the embodiments described in the Detailed Description below.

### BRIEF DESCRIPTION OF THE DRAWING(S)

The foregoing and other beneficial features and advantages of the invention will become apparent from the following detailed description in connection with the attached figures, of which:

FIGS. 1A-1D are plots of temperature profiles of a sample ground assembly (“GA”) of an inductive wireless power transfer (“WPT”) system when active.

FIG. 2 is a diagram of a high-level design for an inductive high-power WPT system with active and passive heat management elements for use with electrical vehicles with battery storage in a sample configuration.

FIGS. 3A and 3B are diagrams illustrating the passive heat flows from an exemplary singular and 2×2 modular ground coil assembly installation, respectively.

FIG. 4A is a diagram illustrating a conventional curbside wireless charger installation.

FIG. 4B is a diagram illustrating a minimum footprint curbside wireless charger installation for managing a GA installation's active and passive thermal dissipative sources in a sample configuration.

FIG. 5 is a diagram illustrating an example of a two-part passive cooling structure where the heat exchanger structure is disguised as a light post in a sample configuration.

FIGS. 6A and 6B are diagrams illustrating semi-active heat exchanger structures for use with a WPT system where the heat exchanger structure is disguised as a bollard in sample configurations.

FIGS. 7A and 7B are diagrams illustrating heat exchanger structures for use with a WPT system where the heat exchanger structure is disguised as a light post in sample configurations.

FIG. 8 is a diagram of an exemplary parking-lot based charging station with multiple WPT chargers and coordinated thermal management in a sample configuration.

FIG. 9 is a diagram illustrating a passive thermal management system using the earth as a heat sink in a sample configuration.

FIG. 10 is a diagram illustrating a mixed passive and active thermal management system for a loading dock application used for wireless charging in a sample configuration.

FIG. 11 is a diagram illustrating a system for boosting the efficiency of a WPT system using a building with a WPT heat reuse system to increase overall WPT efficiency in a sample configuration.

FIG. 12 is a schematic diagram of an actively cooled WPT system in a sample configuration.

FIG. 13A is a diagram of a cut-away view of a passive/active hybrid thermal management system for an outdoor application of wireless charging in a sample configuration.

FIG. 13B is a diagram of a configuration for an in-line coolant line through a reservoir in a sample configuration.

FIG. 13C is a diagram of an alternative configuration for an in-line coolant line through a reservoir in a sample configuration.

FIG. 14A is a diagram of a charger installation using a narrow trench backfilled with large, low-density aggregate.

FIG. 14B is a diagram of a charger installation using a wide trench backfilled with a dense aggregate.

FIG. 14C is a diagram of a representative sample of a large aggregate fill in the compacted and filled form as installed in the trench of FIG. 14A.

FIG. 14D is a diagram of a representative sample of a small aggregate fill in the compacted and filled form as installed in the trench of FIG. 14B.

FIG. 15 is a diagram illustrating a thermal reuse installation at a bus stop equipped with a WPT charger in a sample configuration.

FIG. 16A is a diagram illustrating one view of a reuse scenario and structure where thermal energy produced during a WPT charging session is conveyed to collocated piping in a sample configuration.

FIG. 16B is a diagram illustrating a second view of a reuse scenario and structure where thermal energy produced during a WPT charging session is conveyed to collocated piping in a sample configuration.

FIG. 17 is a flow chart illustrating a method for management of a ground assembly (“GA”) installation's active and passive thermal dissipative resources before, after, and during a wireless charging session in a sample configuration.

### DETAILED DESCRIPTION

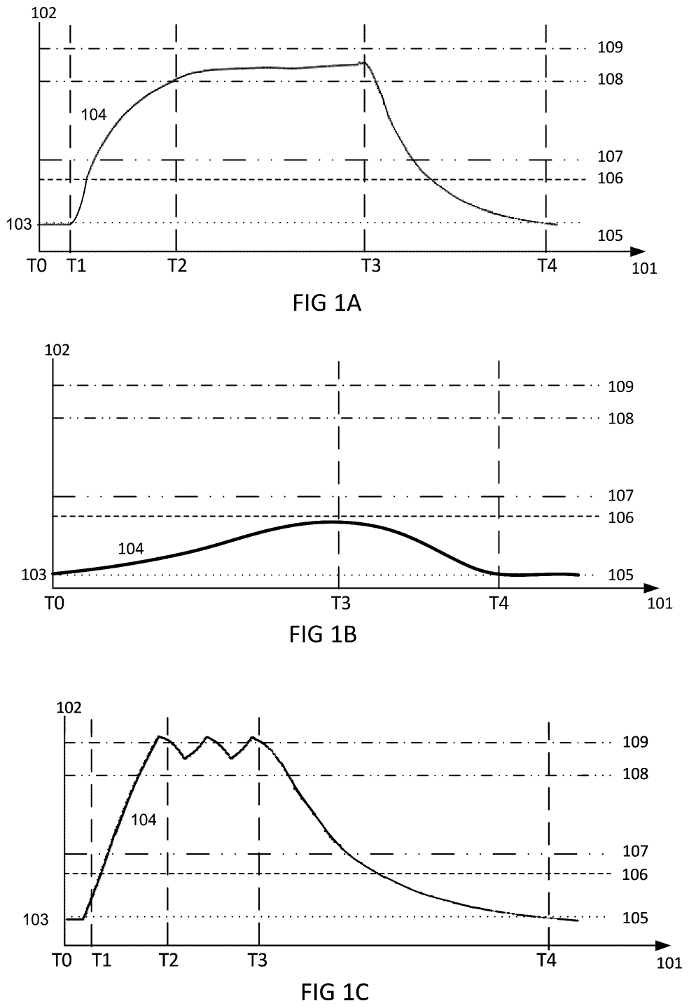

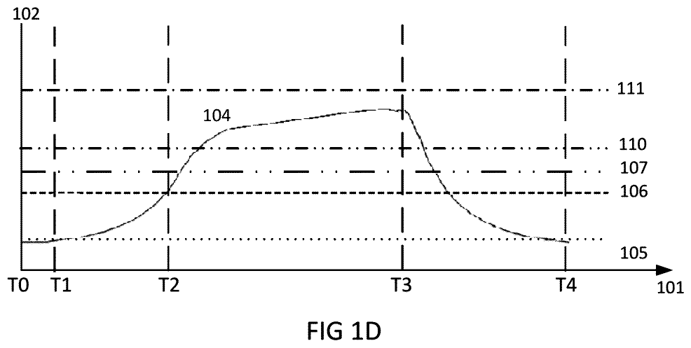

A detailed description of illustrative embodiments will now be described with reference to FIGS. 1-17. Although this description provides a detailed description of possible implementations, it should be noted that these details are intended to be exemplary and in no way delimit the scope of the inventive subject matter.

Thermal management of a Wireless Power Transfer (WPT) system has three primary goals. The first goal is to prevent thermal damage to the WPT system during a charging session. The second goal is to increase efficiency of the system by reduction of the power needed for running the required cooling system(s). The third goal is to extend charger operational life by preventing electronics fatigue failures due to thermally induced stresses and strains caused by thermal expansion/contraction cycles, especially in the winter season or generally cold environs and during the summer season or generally hot environs.

As efficiency of the WPT charger increases, the need for cooling will decrease. As the deployments of WPT chargers (especially WPT opportunity chargers) increase, the need for flexible cooling arrangements will necessarily increase as will the need for camouflaged, disguised, or dual-use cooling structures.

There are many different approaches for cooling electrical components, such as WPT chargers, a few of which are passive cooling, semi-active cooling, and active cooling. Passive cooling techniques and structures require no direct application of external power to produce a cooling effect. Active cooling techniques consume external power from the use of pumps, fans, and chillers to produce a cooling effect. Hybrid, semi-active cooling techniques involve passive cooling structures that have enhanced cooling with active elements that can be enabled as needed to produce a cooling effect.

A heat exchanger is a device that facilitates the process of heat exchange between two fluids that are at different temperatures. Cooling (i.e., removing heat from a system) is typically achieved by heat transfer or exchange to the outside air. The concept of heat transfer forms the basis of all air and fluid conditioning systems and works on the principle of allowing a medium, generally a liquid or gas, to absorb heat from one location and move it to another location. Heat exchangers typically make use of water or other coolant to affect this transfer of thermal energy. Most work by channeling water or other coolant through a series of tubes or vessels where they either absorb or shed heat through the flow path surfaces. Obviously, the larger those surfaces are, the larger the heat transfer area and the better the heat exchanger will work.

Heat exchangers influence the overall system efficiency and system size. The heat exchanger designs balance between heat exchanger effectiveness and pressure drop to achieve the desired tradeoff between system efficiency and system size. This tradeoff between system efficiency and system size will vary with each heat transfer system application.

The three major types of heat transfer systems (fluid-to-air) include:

Tube Fin Heat Exchangers, also called finned coil heat exchangers, which consist of tubes that pass through a dense fin stack that is mechanically supported by a frame. Heated fluid passes through the tube coils, conducts heat to the fins, and dissipates heat to the air around the fins.

Bare or Plain tube heat exchangers consist of tubes that pass through an arrayed bundle that is mechanically supported by a frame. Heated fluid passes through the tubes, conducts heat via the outside tube surface, and dissipates heat to air passing through the heat exchanger.

A plate coil heat exchanger is constructed from heat conductive plates which are embossed with a predetermined pattern on one or both sides. Mated with the corresponding second plate, they form a coolant channel between the plates. Circulated coolant has both the channel and the entire plate surface as a radiating mechanism to shed heat. This design allows for large radiating areas using assemblies of various flat or curved forms.

Hybrids of these three heat exchangers are possible including those that use an intermediate heat transfer fluid-to-fluid (other than air) arrangement.

Other types of heat exchangers including evaporative or phase-change refrigerant can be used to cool the WPT ground charger in atypical deployments.

Use of passive heat dissipative conduits and radiative structures can be used to cool the WPT charger reducing the need for active cooling. For a WPT system ground charger, active cooling includes pump or fan-driven movement of coolant or air carrying generated heat in the charger to heat exchangers and/or radiators. Active cooling efficiency can be increased by the replacement, supplement, or enhancement by installation of passive radiative structures that function without, for example, forced air resulting in electrical savings.

Hybrid, or semi-active, cooling systems combine elements from both active cooling and passive cooling systems to provide adjustable control of cooling rates and levels. Dual-use arrangements where the heat generated by the WPT ground charger is reused can be an alternative cooling method in some WPT installations. Both passive and active cooling schemes can be used in dual use structures. The dual-use structures may include common roadside structures such as curbs, sidewalks, light posts, and bollards which can also serve to camouflage a charger installation as well as to reduce the footprint of a WPT installation, discussed further below.

Heat reuse may be passive or active but either raises efficiency of the WPT ground charger as a co-generator of heat for secondary uses such as for heating air for forced air heating systems, water for radiant heating, or water for domestic/business hot water systems.

The use of a hybrid active/passive (i.e. semi-active) cooling system for WPT systems is bounded both by cost and by deployment opportunity. In-building WPT systems with hybrid active/passive cooling, for instance, will vary greatly from outdoor WPT systems with hybrid active/passive cooling systems. In addition, indoor WPT systems may differ in installation from each other greatly for newly constructed facilities versus retrofitted buildings.

The intended duty cycle of the WPT system/charger will also affect hybrid active/passive cooling system options. For a low duty cycle or low power (either by design or constrained) WPT charger, the interval between charging sessions may be long enough for the deployed passive cooling elements to radiate and to buffer the heat produced during the charging session and to continue to discharge the heat during the inter-charging interval to or below a threshold level. A greater construction outlay in building the passive elements (heat exchangers, radiators, evaporators) results in a higher WPT efficiency by limiting the need for powered active cooling.

Climate and seasonality affect the mix of active and passive cooling elements in a hybrid cooling system as the temperature differentials achievable by the passive elements will necessarily decrease in hot climates and seasons.

Outdoor locations may affect the deployable mix of active and passive cooling elements dependent on the deployment scenario, e.g., closely deployed multiple chargers could share passive or active cooling resources.

The need to minimize the footprint of cooling apparatuses for use in high value areas (e.g., along-side streets, in parking lots, in residential areas, in depots, in loading docks) will increase as opportunity charging of EVs becomes more prevalent. The camouflaging or disguising of cooling structures also serves to lower visibility to vandals, saboteurs, or the destructively overly curious.

Sample active, semi-active, and passive cooling configurations will be described below, with respect to FIGS. 1-17, that can be utilized to cool or reduce the temperature of WPT systems that wirelessly transfer power to remote systems such as vehicles including batteries.

Cooling systems can be divided into passive, semi-active, and active based on the power and equipment used. With modular inductive WPT chargers, the range of power delivered can vary from the minimum for a single inductive coil to the maximum delivered by all coils within the charger installation.

Passive systems cool without need for fans or pumps, making that the most efficient choice. Passive cooling is well suited to chargers that are infrequently used or only used at lower power settings. While passive heat exchanger systems can be scaled for more frequency use and high-power charging sessions, the passive cooling infrastructure can become quite extensive both in size and cost rendering it unsuitable for many WPT installation sites.

Semi-active systems may use both passive (e.g., heat pipes, thermosiphons, chimney cooling) and active components (e.g., pumps, fans). Maximum efficiency is achieved by using the active components only when necessary to shed heat faster than the system can passively. Semi-active cooling systems are generally smaller in scale than passive systems and have improved heat exchange capabilities. By advantageous enablement and selective control of fan speeds and/or pump flow rates, the heat exchangers can be scaled to both to shed varying thermal load from the WPT charger, but also handle daily or seasonal changes in the ambient air and ground temperatures.

Active systems use active components (pumps, fans) to transfer and shed the heat resulting from an inductive charging session. The active components are controlled to transfer and shed the charger generated heat during a session but may be disabled in-between sessions once a target temperature has been reached to maximize efficiency. Active systems can be scaled with the addition of external heat exchangers or supplemental cooling (e.g., refrigeration of coolant).

An inductive WPT system can include passive, semi-active and active cooling subsystems. Cooling subsystem design is based on anticipated power transfer, charger duty cycle, and external environmental factors which may include the need to conceal or disguise the external heat exchangers or siting of the external heat exchangers at inconvenient distances from the charger.

### FIG. 1A

FIG. 1A is an illustrative example plot of a temperature profile of a sample ground assembly (“GA”) of an inductive WPT system over time. The WPT system in the FIG. 1A example is served by both passive cooling and active cooling. The x-axis 101 of the plot shows time and the y-axis 102 of the plot shows temperature. At time zero (T0), the GA has been inactive long enough for the GA temperature to fall to a quiescent temperature (i.e., residual temperature level) 103. At time zero (T0), the GA starts a charging session. The temperature profile line 104 climbs until shortly after time T1 it reaches the passive threshold 106. The passive threshold 106 is the safety limit for the passive cooling of the GA prior to reaching heat saturation. At the passive threshold 106, active cooling is enabled before the temperature profile line 104 reaches the passive cooling limit 107. With both the saturated passive cooling and active cooling systems engaged, the GA coil temperature can continue to climb until it reaches the nominal safe operating temperature 108 at time T2. While the temperature profile 104 may fluctuate around the nominal safe expected temperature 108, the temperature is always held under the shutdown temperature 109. Assuming a normal wireless charging session, the session ends at time T3. After the end-of-session time T3, active cooling continues until at least the residual threshold 103 is reached at time T4. Further, active cooling may assist in cooling the passive cooling components to below the residual temperature level 103 (in some cases cooling further to below the ambient temperature). Cooling to below the residual temperature level 103 may be performed to build up the passive cooling capacity reservoir for the next charging session if another charging session is not immediately needed after time T4.

### FIG. 1B

FIG. 1B is an illustrative example plot of a temperature profile of a sample ground assembly (“GA”) of an inductive WPT system over time. The WPT system in the FIG. 1B example is served by passive cooling that is sized to cool the GA for a maximum current and duration charging session. The x-axis 101 of the plot shows time and the y-axis 102 of the plot shows temperature. At time zero (T0), the GA has been inactive long enough for the GA temperature to fall to a quiescent temperature (i.e., residual temperature level) 103. At time zero (T0), the GA starts a charging session. During the charging session, the temperature profile line 104 climbs but never exceeds the passive threshold 106. The charging session ends at time T3 and the GA begins to cool until it reaches the residual temperature level 103 at time T4. The GA can then be flagged, or otherwise indicated, as being available for the next charging session. Therefore, as illustrated, the inductive WPT system including both passive and active cooling (FIG. 1A) can operate at a significantly higher temperature than the inductive WPT system including only passive cooling (FIG. 1B).

### FIG. 1C

FIG. 1C is an illustrative example plot of a temperature profile of a sample ground assembly (“GA”) of an inductive WPT system over time. The WPT in the FIG. 1C example is served by both passive cooling and active cooling, similar to FIG. 1A. The x-axis 101 of the plot shows time and the y-axis 102 of the plot shows temperature. At time zero (T0), the GA has been inactive long enough for the GA temperature to fall to a quiescent temperature (i.e. residual temperature level) 103. At time zero (T0), the GA starts a charging session. The temperature profile line 104 climbs until shortly after time T1 it reaches the passive threshold 106. The passive threshold 106 is the safety limit for the passive cooling of the GA prior to reaching heat saturation. At the passive threshold 106, active cooling is enabled before the temperature profile line 104 reaches the passive limit 107. With both the saturated passive cooling and active cooling systems engaged, the GA coil temperature can continue to climb until it reaches the nominal safe operating temperature 108 between time T1 and time T2. Due to any number of factors (unplanned for weather conditions, cooling equipment damage, higher-than planned charging cycle time and/or charging current demand), the active cooling is inadequate to keep the GA temperature below the shutdown temperature 109. As shown in FIG. 1C, the GA may shutdown briefly to cool. In the FIG. 1C example, the GA re-engages the charging session once the temperature profile 104 drops below the shutdown temperature 109 but since a negotiated lower current demand has not been reached between the GA controller and the vehicle Battery Management System (BMS), the GA will shut down until a maximum shutdown value has been reached/exceeded (three in the FIG. 1C example).

Having exceeded the maximum shutdown value, the charging session ends at time T3. After the end-of-session time T3, active cooling continues until at least the residual temperature level 103 is reached at time T4. Further, active cooling may assist in cooling the passive cooling components to below the residual temperature level 103. Cooling to below the residual temperature level 103 may be performed to build up the passive cooling capacity reservoir for the next charging session if another charging session is not immediately needed after time T4.

### FIG. 1D

FIG. 1D is an illustrative example plot of a temperature profile of a sample ground assembly (“GA”) of an inductive WPT system over time. The WPT system in the FIG. 1D example is served by semi-active cooling that is sized to cool the GA for a maximum current and duration charging session with the expected highest (hottest) daily temperature. The x-axis 101 of the plot shows time and the y-axis 102 of the plot shows temperature. At time zero (T0), the GA has been inactive long enough for the GA temperature to fall to a quiescent temperature (i.e. residual temperature level) 103. At time zero (T0), the GA starts a charging session. The temperature profile line 104 climbs until shortly after time T1 it reaches the passive threshold 106. The passive threshold 106 is the safety limit for the passive cooling components of the GA prior to reaching heat saturation. At the passive threshold 106, the semi-active cool elements are enabled before the temperature profile line 104 reaches the passive limit 107. At any point when the GA Coil temperature 104 exceeds the passive limit, semi-active components can be enhanced (e.g., by increasing fan or pump speeds) or additional semi-active components can be enabled, as to better manage the increasing heat. In this example, the GA coil temperature 104 can continue to climb until it exceeds a first semi-active threshold 110 at which point additional cooling is applied. With the additional cooling, the temperature 104 is maintained in the nominal safe operating temperature below the cut-off temperature threshold 111. At time T3, the charging session ends and the WPT system is allowed to cool to a quiescent temperature 105 at time T4. Depending on environmental and usage factors (e.g., time-of-day, ambient temperature, expected frequency of use, average power level) the semi-active components may be disabled once the temperature 104 has dropped below the passive limit 107 to reduce power consumption.

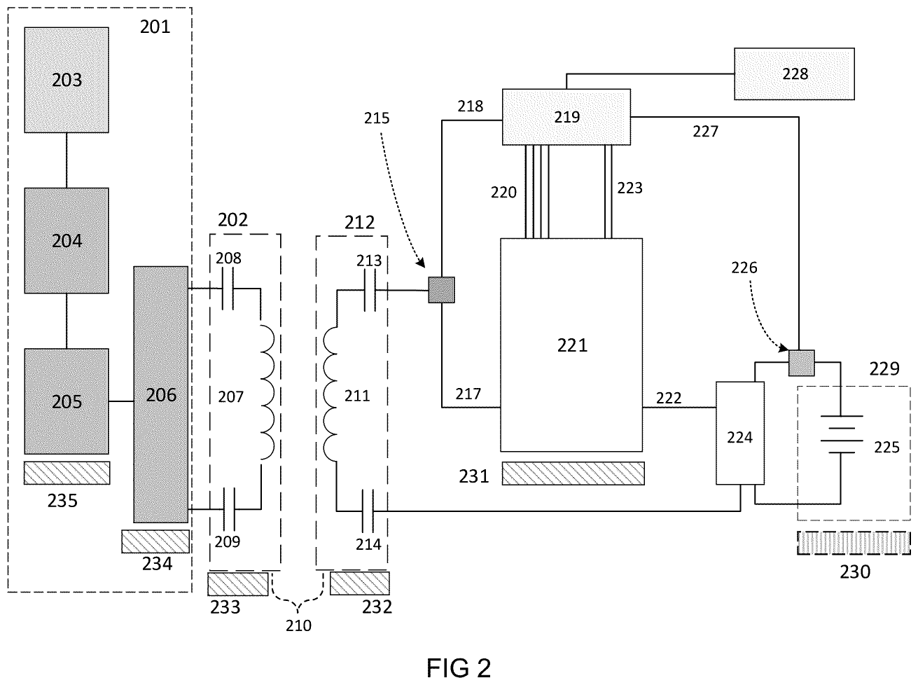

### FIG. 2

FIG. 2 is a diagram of a high-level design for an inductive high-power WPT system with active and passive heat management elements for use with electrical vehicles with battery storage. In this system, the ground-side electronics 201 provides a conditioned power signal to the primary coil assembly 202. The ground side electronics 201 includes, in this example, an interface to the utility grid 203, power factor correction (PFC) circuitry 204, an AC/DC converter 205, and a DC/AC inverter 206.

As preferred in high power WPT systems, the primary coil assembly 202 may have a balanced series resonant configuration including the primary coil windings 207 and matched capacitors 208 and 209. Across an airgap 210, the secondary coil assembly 212 includes a secondary coil winding 211 that receives the magnetic signal generated by the primary coil winding 207. The secondary coil assembly 212 also may have the balanced series resonant configuration including the secondary coil windings 211 and matched capacitors 213 and 214.

The AC power level, frequency, and phase (i.e., the AC power signal data) generated by the secondary coil assembly 212 is measured by a sensor 215 in the secondary-to-rectifier bus 217 which reports these measurements via digital datalink 218 to the active rectifier controller (ARC) 219. The ARC 219 may use the AC signal data to predictively model the signal to determine zero crossings to optimize the active rectification. Rectification control signaling is passed via control links 220 to the active rectifier 221, which takes the AC signal from the secondary-to-rectifier bus 217 and converts the AC input to a DC power output 222.

Temperature sensors in the rectifier module 221 (not shown) use digital datalinks 223 to report the measured temperatures to the ARC 219. The power conditioner 224 takes the rectifier DC output 222 and removes ripple and noise to charge the battery pack 225. The conditioned DC signal characteristics are monitored by a sensor 226 and reported back to the ARC 219 via digital datalink 227. The ARC 219 reports both AC and DC power characteristics to a networked controller 228 for storage and reporting.

The high-power components of the WPT system will require cooling during operation to prevent damage and/or overheating of the WPT system. The EV power electronics 229 (the EV battery pack 225 and other vehicle systems) will require its own cooling solution, in this example forced air cooling through a heat exchanger 230.

The WPT rectifier 221 cooling may be shared with the EV heat exchanger 230 or a separate heat exchanger 231 may be used. The secondary coil assembly 212 cooling is shown as using a distinct heat exchanger 232, but the vehicle heat exchanger 230 and/or the separate heat exchanger 231 may be shared to cool the secondary coil assembly 212. No cooling connection between the groundside and vehicle-side is shown in this exemplary system.

The ground-side primary coil assembly 202 may have its own dedicated heat exchange mechanism 233 for cooling the ground-side primary coil assembly 202. The inverter 206 also requires cooling, shown here as provided by the heat exchanger 234. The AC/DC converter 205 will also generate heat during normal operation of the WPT system, thus requiring cooling by heat exchanger 235.

The inverter 206 and AC/DC converter 205 also may share a cooling system with each other and the other ground-side electronics systems. Since the primary coil assembly 202 can be deployed a distance away from the rest of the groundside electronics 201, distinct and independently scalable cooling elements may be needed.

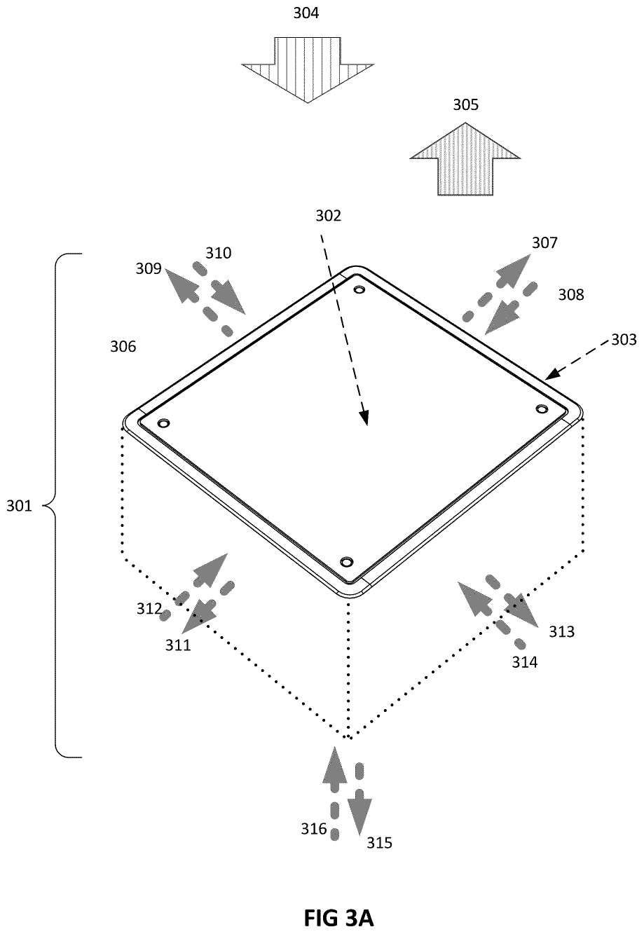

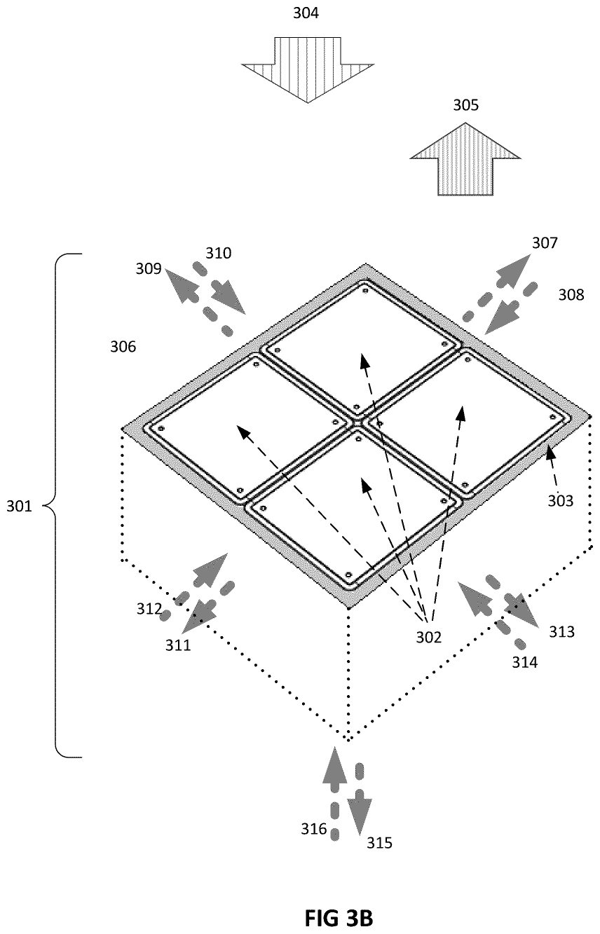

### FIGS. 3A and 3B

FIGS. 3A and 3B are diagrams illustrating the passive heat flows from an exemplary singular and 2×2 modular ground coil assembly installation, respectively. In FIG. 3A, a modular GA 301 consisting of a single ground coil assembly 302 embedded in the road surface 306 is shown, and in FIG. 3B, a modular GA 301 consisting of 4 (a 2×2 grid) ground coil assemblies 302 embedded in the road surface 306 is shown. In either configuration, a vault 303 surrounds the GA 301 on all sides and underneath, contiguous except for pass-throughs for the underground electrical, communications, and active cooling connections (not shown). Solar heating 304 is unavoidable and only partially countered by thermal reflection and convection 305 from the GA surfaces. Passive temperature flows for each side and underside of the vault 303 are shown. The GA-to-ground thermal outflows 307, 309, 311, 313, and 315 during a charging session can exceed the ground-to-GA thermal inflows 308, 310, 312, 314, and 316 quickly in the absence of passive cooling heat transfer structures or active cooling systems. In certain low power or limited duration (with long intervals between) WPT charging scenarios (and when the ambient is low enough), the passive ground-to-GA thermal inflows 308, 310, 312, 314, and 316 may suffice for WPT charger cooling. In other examples, the passive ground-to-GA thermal inflows 308, 310, 312, 314, and 316 may be insufficient and active or semi-active cooling may be required.

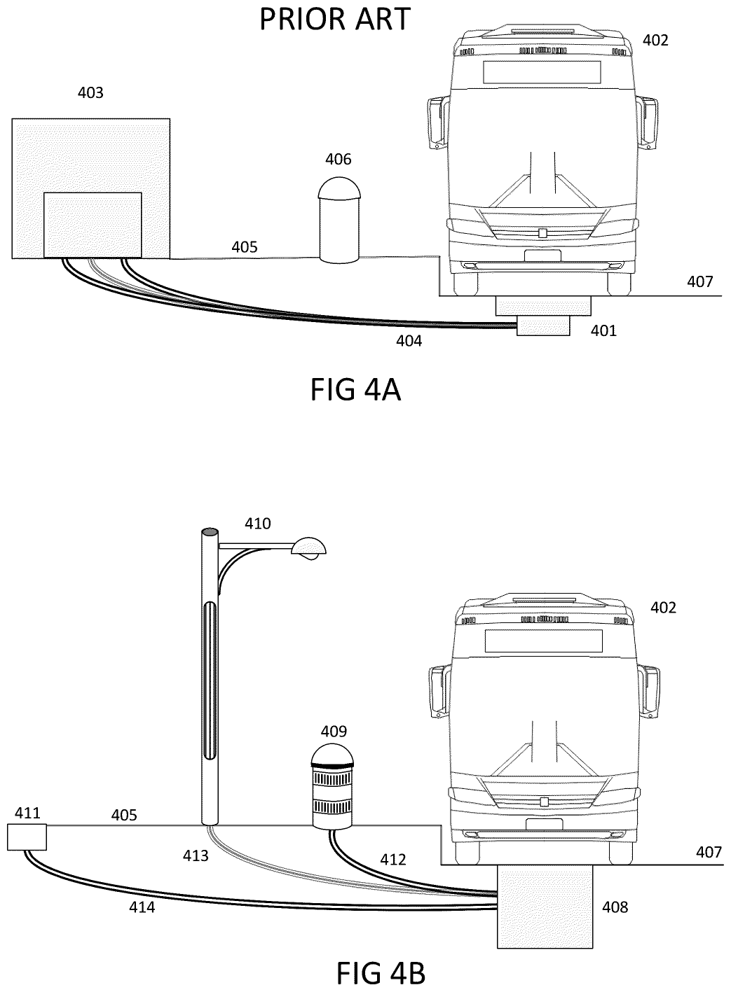

### FIG. 4A

In FIG. 4A, an example of a conventional curbside wireless charger installation is shown at a high-level. In this example, the wireless charger 401 is shown positioned within the road surface and configured to charge the suitably equipped EV 402 (in this example, an electric bus). The electrical power and cooling for the wireless charger 401 are provided from a remotely located equipment cabinet(s) 403. While situated some distance from the wireless charger 401 on or near the curb, the equipment cabinet 403 is preferably located as close as possible to the wireless charger 401 to reduce the cost of interconnections 404 (e.g., high-current cabling, cooling pipes, communication wiring or fiber) and cost and scope of installation trenching, among other costs associated with installation of the wireless charger.

In the example illustrated in FIG. 4A, the sidewalk and pedestrian walkways 405 are necessarily reduced in area due to the need for the equipment cabinet(s) 403, which is not necessarily desirable depending on the location of the WPT system. Existing traffic control structures and pedestrian protective structures, shown here by the bollard 406, may already exist on the pedestrian walkways 405 before installation of the wireless charger 401 and remote equipment cabinet(s) 403. The sidewalk 405 and pavement 407 in this example may continue in parallel fashion, or the pavement 407 may be looped, reducing the interface between the pavement 407 and pedestrian walkways 405 and further concentrating boarding and disembarking foot traffic to limited area.

### FIG. 4B

In FIG. 4B, an example of a minimized footprint curbside wireless charger installation for managing a GA installation's active and passive thermal dissipative sources is shown at a high-level.

In the space-efficient example of FIG. 4B, an improved wireless charger 408 is positioned within the road surface and configured to charge the suitably equipped EV 402 (in this example, an electric bus). The electrical power in the FIG. 4B example is provided from a remotely located interconnection 411 to a utility DC supply via buried wiring 414 and the DC-to-AC conversion accomplished within the wireless charger 408 embedded in the pavement 407.

Cooling capability for the wireless charger 408 in this example is represented by the vented bollard 409 and the vented light post 410, each positioned on the pedestrian walkways 405 and separate from the interconnection 411. Connected by piping 412 to the wireless charger 408, the vented bollard 409 may be a passive, active, or semi-active radiator (heat exchanger) of waste heat. In active mode, coolant can be pumped from the improved wireless charger 408 to the vented bollard 409 where exhaust fans are used to air-cool the coolant passing through the internal heat exchanger (not shown). In passive-mode, a heat-pipe or heat siphon may connect the improved wireless charger 408 to the vented bollard 409 which then uses the chimney effect to draw air over the internal heat exchanger (not shown) to reduce the temperature of the coolant. In a semi-active mode, coolant is pumped from the improved wireless charger 408 to the vented bollard 409 where the chimney effect draws air over the internal heat exchanger (not shown) providing cooling to the coolant as well as the improved wireless charger 408.

Similarly, the light post 410 can also serve as a cooling structure for the improved wireless charger 408. The light-to-charger interconnect 413 may be a pressurized coolant line, a heat pipe, or a heat siphon (also known as thermosiphons). Passive heat pipes can be used up to 3 meters, while heat siphons can be used for 10-to-15 meters of charger-to-heat exchanger separation. Like the vented bollard 409, the vented light post 410 may function as the heat radiator for a passive, semi-active, or active cooling system. In active mode, coolant can be pumped from the improved wireless charger 408 to the vented light post 410 where exhaust fans are used to air-cool the coolant passing through the internal heat exchanger (not shown). In passive-mode, a heat-pipe or heat siphon may connect the improved wireless charger 408 to the vented light post 410 which then uses the chimney effect to draw air over the internal heat exchanger (not shown) to reduce the temperature of the coolant. In a semi-active mode, coolant is pumped from the improved wireless charger 408 to the vented light post 410 where the chimney effect draws air over the internal heat exchanger (not shown) providing cooling to the coolant as well as the improved wireless charger 408.

In the FIG. 4B example, the impact of adding a wireless charging system to above-ground pedestrian spaces is lessened, compared to the FIG. 4A example, because the heat exchangers are positioned within the vented bollard 409 and/or the vented light post 410 instead of the remote equipment cabinet(s) 403. Further, conversion to DC power feeds leads to elimination of the equipment cabinet 403 positioned on the pedestrian walkways 405. In addition, conversion of existing structures or the addition of dual-use structures or arrangements (in the FIG. 4B example, the light post 410 provides both illumination as well as cooling; and the bollard provides the pedestrians protection for vehicle collisions as well as cooling) further minimizes the impact to the passable aboveground areas, such as the pedestrian walkways 405.

The addition of the light post 410 also allows siting of overlooking camera(s) for use in a Foreign Object Detection (FOD) system (as in U.S. patent application “FOREIGN OBJECT DETECTION FOR WIRELESS POWER TRANSFER SYSTEMS”, Ser. No. 17/659,452, filed Apr. 15, 2022.

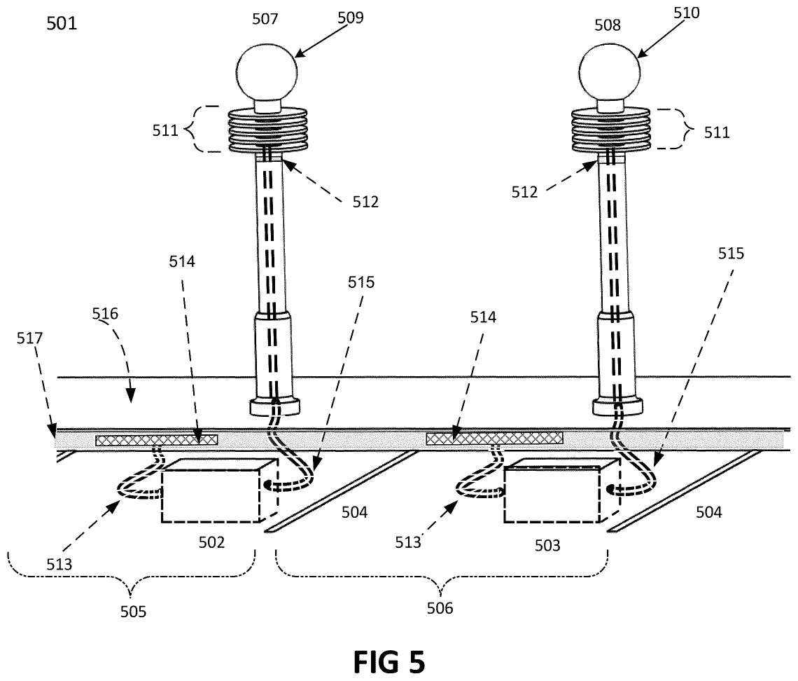

### FIG. 5

FIG. 5 is a diagram illustrating an example of a two-part passive cooling structure where the heat exchanger structure is disguised as a light post in a sample configuration. In FIG. 5, a pair of GAs 502 and 503 are shown in a charging site delineated by surface markings 504 into charging positions 505 and 506. The GAs 502 and 503 are modular and may be comprised of a single or multiple coil assemblies. The guidelines for parking and alignment navigation assistance are not shown.

Light posts 507 and 508 are adapted for passive cooling, and the light posts 507 and 508 are shown placed on the sidewalk 516 next to the charging positions 505 and 506. A passive radiative structure 511 is provided above optional insulative band 512 on each light post 507 and 508. The radiative structures 511 are out-of-reach of any pedestrians on the sidewalk 516. The radiative structures 511 act as the condenser ends of heat siphons 515 of light posts 507 and 508, respectively, where the evaporative end is within the GAs 502 and 503.

Additional passive heat exchanger structures 514 are shown connected to the metal-faced radiative curb 517. Heat pipes 513 connect the GAs 502 and 503 to each of the passive heat exchanger structures 514, with the evaporative end of the heat pipes 513 within the GAs 502 and 503 and the condenser ends of the heat pipes 513 attached to the passive heat exchanger structures 514, illustrated in this example as curb radiators 514. The curb radiators 514 provide extra passive cooling of the GAs 502 and 503, in addition to the light posts 507 and 508.

The heat siphons 515 and the heat pipes 513 can be designed (by selection of the working fluid and internal pressure) to engage at the same or differing temperature thresholds. Temperature sensors (not shown) in the radiative structures 511 of in the light posts 507 and 508, and on the radiative curb 514 can be used to engage active cooling if the heat of the light posts 507 and 508 or the radiative curb 514 exceeds a touch safety threshold base on a legal or safe limit (e.g., ASTM C1055, “Standard Guide for Heated System Surface Conditions that Produce Contact Burn Injuries”).

As the radiative curb 514 and the light posts 507 and 508 may raise the temperature of the ambient air and/or the sidewalk, the arrangement shown in FIG. 5 can be considered a dual-use system for the melting of snow and ice during the winter or other cold environmental conditions.

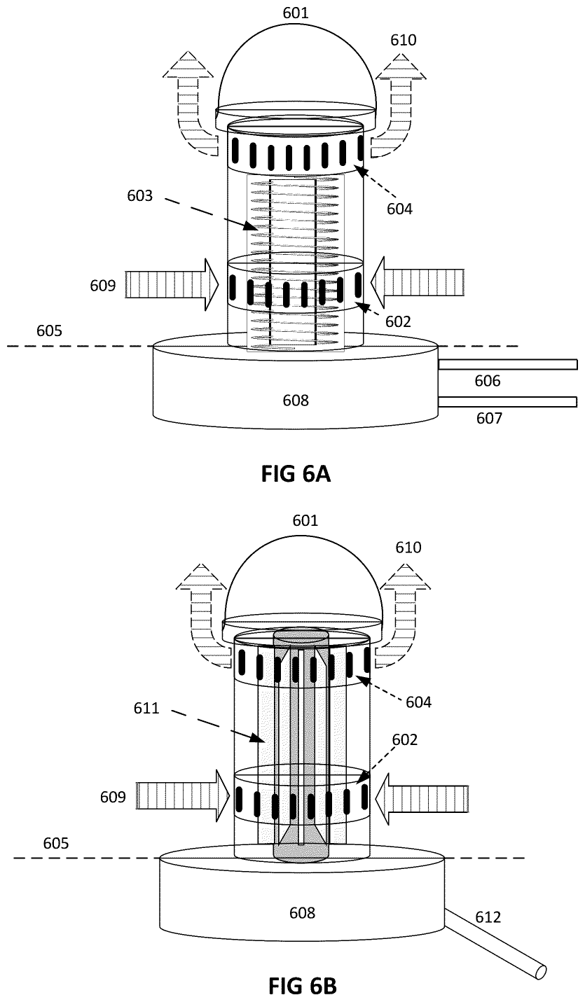

### FIG. 6A

FIG. 6A is a semi-transparent diagram illustrating a semi-active heat exchanger structure for use with a WPT system where the heat exchanger structure is disguised as a bollard 601, in sample configurations. Based on a bollard design (i.e., a post used to create a protective or architectural perimeter for buildings and pedestrian areas), the heat exchange bollard 601 uses heat mass and the chimney effect to passively cool the WPT system (not shown). The bollard 601 has a plurality of air inlets 602, a heat exchanger 603 (which is shown in this example as a spiral coil), and a plurality of air outlets 604. The plurality of air inlets 602 are positioned below a vertical mid-point of the bollard 601 near a bollard base 608, and the plurality of air outlets 604 are positioned above the vertical mid-point of the bollard 601 furthest from the bollard base 608. The bollard 601 takes advantage of the shape of the bollard 601 and the space within the bollard 601 to utilize the stack (or chimney) effect to cool coolant flowing into the bollard 601 through incoming piping 606. As shown in FIG. 6A, the bollard base 608, the incoming piping 606, and outgoing piping 607 are each shown below grade 605.

The bollard 601 in FIG. 6A operates with semi-active cooling, that is with pumped coolant from the GA(s) passing through a passive heat exchanger 603 positioned within the bollard 601. More specifically, the coolant is transferred from the GA(s) of the WPT system through the incoming piping 606 and into the bollard 601. Ambient air flows through the plurality of air inlets 602, through the interior of the bollard 601 past the heat exchanger 603, and then out through the plurality of air outlets 604. The air flowing through the bollard 601 removes heat from the coolant flowing through the heat exchanger 603 and then the air is expelled from the bollard 601, and the reduced temperature coolant flows back through the outgoing piping 607 back to the GA(s) of the WPT system. The structure of the bollard 601 could also be adapted for a passive radiative structure for a heat siphon or heat pipe, as shown in FIG. 5, for example. Alternately, the bollard 601 could be equipped with a fan for air handling, increasing the airflow, and thus the heat exchange capacity.

### FIG. 6B

FIG. 6B is a diagram illustrating a passive heat exchanger structure for use with a WPT system where the heat exchanger structure is disguised as a bollard 601, in sample configurations. Based on a bollard design (i.e., a post used to create a protective or architectural perimeter for buildings and pedestrian areas), the heat exchange bollard 601 uses heat mass and the chimney effect to passively cool the WPT system (not shown). The bollard 601 of FIG. 6B has a plurality of air inlets 602, a finned heat exchanger 611, and a plurality of air outlets 604. The plurality of air inlets 602 are positioned below a vertical mid-point of the bollard 601 near a bollard base 608, and the plurality of air outlets 604 are positioned above the vertical mid-point of the bollard 601 furthest from the bollard base 608.

The bollard 601, of FIG. 6B, takes advantage of the shape of the bollard 601 and the space within the bollard 601 to utilize the stack (or chimney) effect to dissipate the heat received from a heat siphon or heat pipe 612 fluidly coupled to the WPT system. The FIG. 6B bollard 601 acts as the radiative structure for the heat siphon or heat pipe 612 (also as shown in FIG. 5). Alternately, the bollard 601 could be equipped with a fan for air handling, increasing the airflow, and thus the heat exchange capacity.

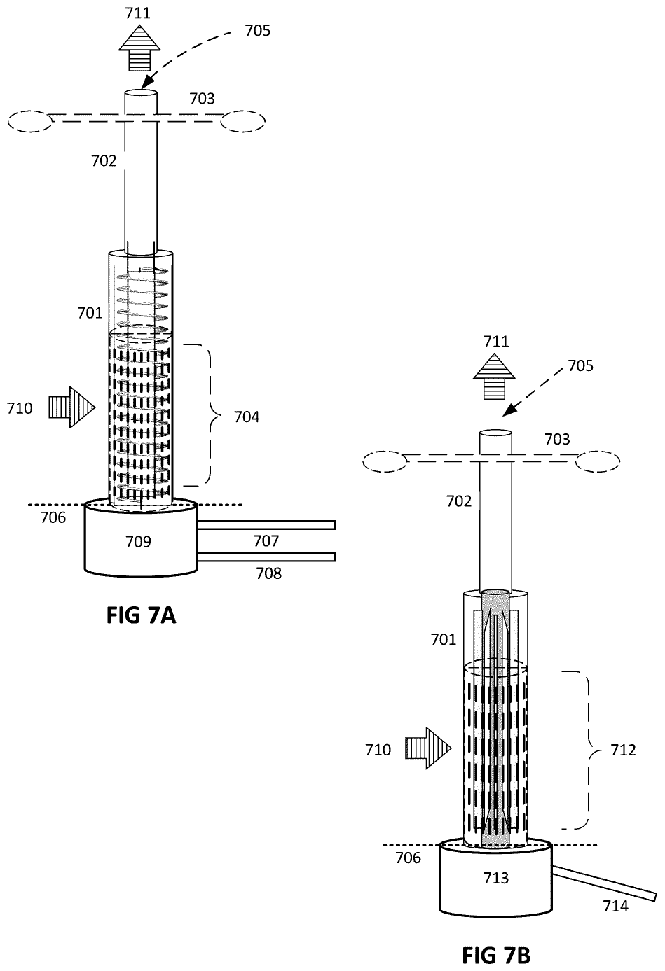

### FIG. 7A

FIG. 7A is a semi-transparent diagram illustrating a semi-active heat exchanger structure for use with a WPT system where the heat exchanger structure is disguised as a light post in sample configurations. In the semi-active cooling example illustrated in FIG. 7A, a central pipe 702 of the light post projects from an insulated sheathing pipe 704 of the light post. Further, the light post includes an air inlet (not shown), a central pipe outlet 705, and a heat exchanger 701 (shown in this example as coil) positioned radially between the central pipe 702 and the insulated sheathing pipe 704. The heat exchanger 701 (shown in this example as a coil) is configured to transfer heat from the coolant flowing into the heat exchanger 701 through the incoming coolant pipe 707 to the air flowing within the central pipe 702. More specifically, the air inlets are positioned immediately above a base 709 of the light post and the air inlets admit ambient cooling air 710 into the central pipe 702, the air flows through the central pipe 702 and the air is heated by the coolant flowing through the heat exchanger 701, and then the heated air is exhausted through the central pipe outlet 705 using the chimney or stack effect as heated exhaust air 711. In addition, the reduced temperature coolant flows from the heat exchanger 701 back through the outgoing piping 708 to the GA(s) of the WPT system (not shown).

In the FIG. 7A example, the central pipe 702 is used to hold floodlights 703 at a top or upper end of the central pipe 702, although other uses are contemplated (e.g., base of advertisements or traffic control signage, antenna mounting, flagpole, etc.). The light post base 709 in FIG. 7A is shown below a grade 706 where the incoming coolant pipe 707 and the outgoing coolant pipe 708 are routed through the base 709. In the FIG. 7A example, the base 709, the incoming coolant pipe 707, and the outgoing coolant pipe 708 are each positioned below the grade 706 to remain out of sight when the system is installed to prevent tampering by pedestrians or damage from any other source. In other examples, the base 709 may extend above the grade 706, but it is preferred that the incoming coolant pipe 707 and the outgoing coolant pipe 708 remain below the grade 706, if possible.

### FIG. 7B

FIG. 7B is a semi-transparent diagram illustrating a passive heat exchanger structure for use with a WPT system where the heat exchanger structure is disguised as a light post in sample configurations. In the passive cooling example illustrated in FIG. 7B, a central pipe 702 of the light post projects from an insulated sheathing pipe 712 of the light post. Further, the light post includes an air inlet (not shown), a central pipe outlet 705, and a heat exchanger 701 (shown in this example as a finned heat exchanger) positioned radially between the central pipe 702 and the insulated sheathing pipe 712. The heat exchanger 701 is configured to transfer heat from the incoming heated air flowing from the heat siphon or heat pipe 714 to the air within the central pipe 702. More specifically, the air inlets are positioned immediately above the base 713 of the light post and the air inlets admit ambient air 710 into the central pipe 702, the air flows through the central pipe 702 and the air is heated by the hot air flowing within the finned heat exchanger 701, and then the heated air is exhausted through the central pipe outlet 705, using the chimney or stack effect, as heated exhaust air 711.

In the FIG. 7B example, the central pipe 702 is used to hold floodlights 703 at a top or upper end of the central pipe 702, although other uses are contemplated (e.g., base of advertisements or traffic control signage, antenna mounting, flagpole, etc.). In the FIG. 7B scenario where the light post structure is used as part of a passive cooling scheme with a heat pipe or heat siphon 714, only a single combined inlet/outlet for the heat pipe or heat siphon 714 is needed, entering below a grade 706 as shown. In other installation scenarios, the base 713 may extend above the grade 706, but it is preferred that the incoming heat pipe or heat siphon 714 remain below the grade 706, if possible.

Both the semi-active cooling embodiment (FIG. 7A) and the passive cooling embodiment (FIG. 7B) of the disguised light-post heat exchanger can be enhanced with the addition of a fan unit (i.e., fan(s), temperature sensors, controller with programmable memory) for greater airflow across or through the heat exchanger. The fan(s) can be selectively enabled (and speed controlled) to add cooling capacity when needed at the expense of the fan unit electrical power needs.

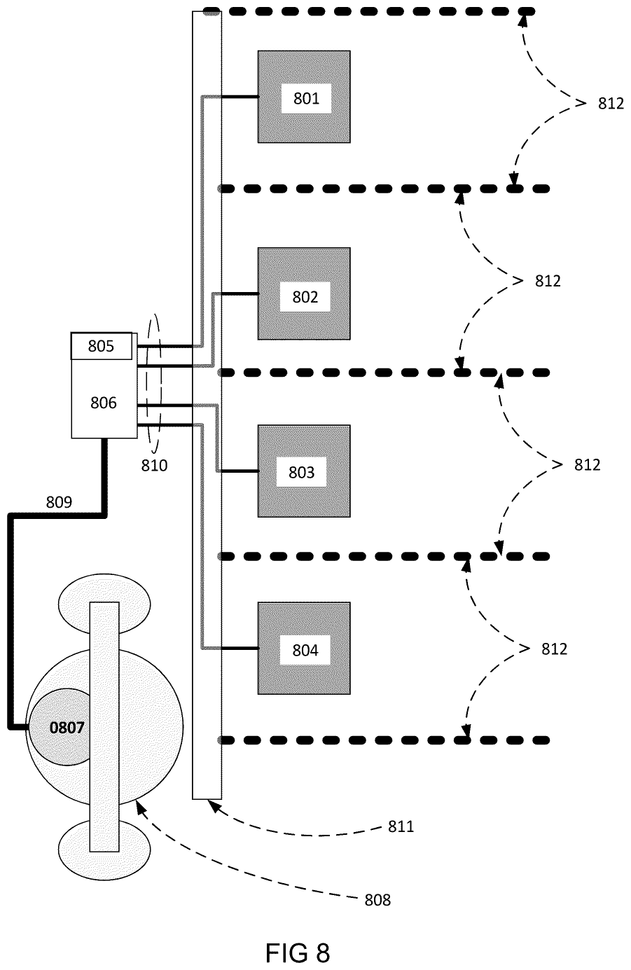

### FIG. 8

FIG. 8 is a diagram of an exemplary parking-lot based charging station with multiple WPT chargers and coordinated thermal management in a sample configuration. The charging station includes multiple WPT chargers (e.g., ground assemblies (GAs)) 801, 802, 803, and 804, each positioned in charger-equipped parking spots defined between a plurality of parking lines or markers 812. A Thermal Management System (TMS) 805 is used to control the Thermal Heat Director (THD) 806 that provides the coolant exchange between any GA (801, 802, 803, or 804) and the coolant reservoir 807. As such, each of the chargers (GAs) 801, 802, 803, and 804 are fluidly coupled to the coolant reservoir 807 for transferring coolant between the coolant reservoir 807 and the chargers 801, 802, 803, and 804. Further, the TMS 805 and the THD 806 are coupled between the chargers 801, 802, 803, and 804 and the coolant reservoir 807 for controlling the coolant exchange. This control further includes use of current atmospheric conditions, GA reported temperature readings, and predictive modeling allowing for individualized delivery of appropriately cooled or heated coolant to the GAs 801, 802, 803, and 804.

The TMS 805 can also send signals to the chargeable vehicles (e.g., via radio signals or indicator lights [not shown]) of the status of a GA(s) 801, 802, 803, and/or 804, for instance that a GA-equipped parking stall is: ready to approach, ready to charge, having a temporary charge interruption (e.g., temperature fault requiring cooling), faulted, not-ready for charging, or any other indicator signal not specifically listed.

In the FIG. 8 embodiment, the coolant reservoir 807 is concealed within the base of a light-post 808. This specialized light-post 808 serves both to provide night-time lighting but also support for heat exchangers and/or radiators to cool the reservoir 807. Additional heat exchangers may be built into the pavement, sidewalks, and bollards as needed or desired. Use of coolant from multiple reservoirs at different temperature levels can be used to provide multiple coolant sources to the THD 806 allowing mixing of coolants to provide heating or cooling as needed to boost energy efficiency.

Interconnection (both to and from) of the THD 806 to the coolant reservoir 807 is accomplished nominally via subsurface piping and wiring 809. In this example, coolant and data interconnections 810 between the THD 806 and GAs 801, 802, 803, and 804 are emplaced within a curb 811 and routed under the parking stall pavement. Each parking stall equipped with a GA 801, 802, 803, and 804 is defined by visible markers 812 that can include painted lines, bollards, raised pavement, or other indicator that the parking stall is equipped with a WPT charger/system.

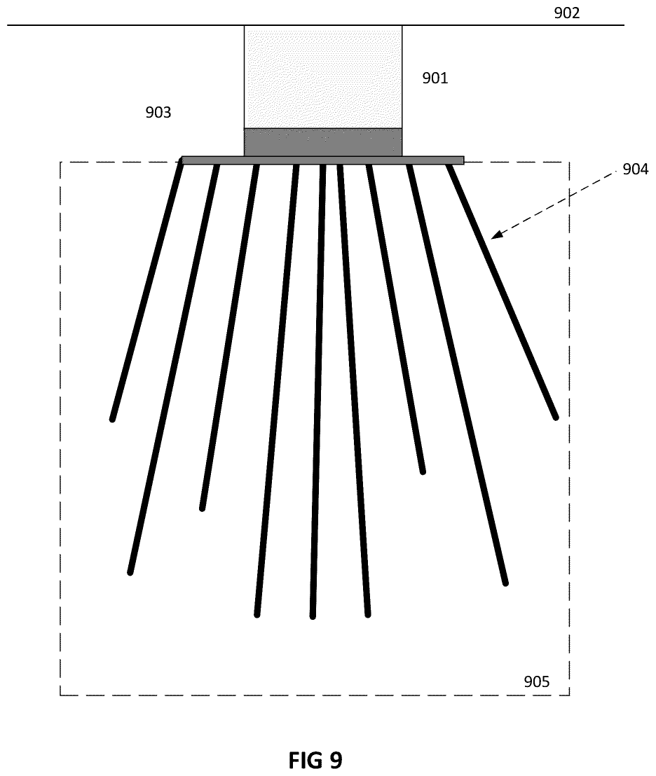

### FIG. 9

FIG. 9 is a diagram illustrating a passive thermal management system using the earth as a heat sink in a sample configuration. In FIG. 9, a wireless charging assembly 901 is installed below grade 902 as in a parking lot, bus stop, or traffic lane. The wireless charging assembly 901 may consist of one or more inductive coil assemblies. The heat produced by the operation of the wireless charging assembly 901 is transferred to a cold plate 903 coupled to the wireless charging assembly 901. In some examples, the cold plate 903 can be positioned under or within the wireless charging assembly 901.

In one example, the cold plate 903 comprises parallel bundles of Litz wire 904. The Litz wire 904 may include miniature, flexible aluminum or copper strands that are film insulated and stranded together into groups that are cabled in a geometric pattern, permitting each wire of the Litz wire 904 to occupy every possible position in the entire length of the cable at some point. The strand size is selected to reduce the skin effect and proximity effect losses, meaning that magnetically induced eddy currents are minimized. By extending the Litz wire 904 into the earth 905 beneath and around the wireless charging assembly 901, a heat sink is formed where thermal energy can be conducted and dissipated without adverse impact on the magnetic charging signal.

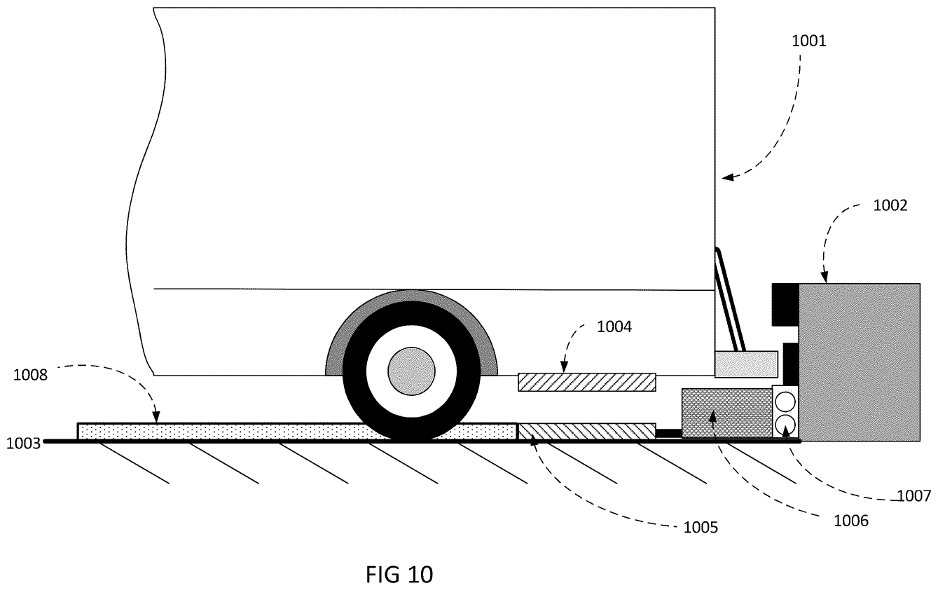

### FIG. 10

FIG. 10 is a diagram illustrating a mixed passive and active thermal management system for a loading dock application used for wireless charging in a WPT system sample configuration. As shown in FIG. 10, a truck 1001 has backed into the loading platform 1002 for loading or unloading of cargo, and for wireless charging a battery within the truck 1001. In this exemplary scenario, the loading platform 1002 is located indoors and the truck 1001 rests on a load-bearing concrete floor 1003.

A wireless receiver 1004 of the vehicle assembly (VA), such as the truck 1001, and a wireless transmitter 1005 of the ground assembly (GA) are utilized to charge the batteries of the truck 1001. The wireless receiver 1004 is positioned on the underside of the truck 1001 chassis to minimize the wireless transmission gap between the wireless receiver 1004 and the wireless transmitter 1005, and to shield personnel and cargo from stray magnetic flux. As illustrated, the ancillary electronics 1006 are mounted on the floor 1003 below the vehicle and between the rear tires of the truck 1001 and the loading dock 1002. Active cooling channels 1007 for air cooling or fluid cooling piping follow along the wall of the loading platform 1002 for venting or radiating outdoors. The cooling channels 1007 may be pre-chilled for greater thermal absorption capacity. Cooling channels 1007 may be shared or dedicated to a particular loading dock 1002 or set of loading docks 1002.

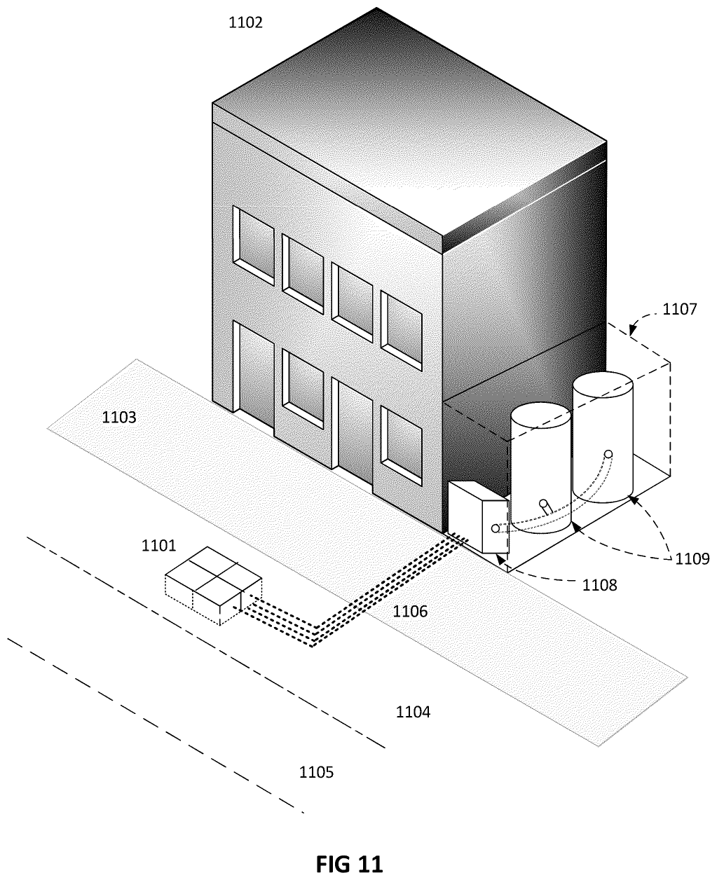

In the FIG. 10 example, a passive cooling pad 1008 may be included which transfers heat generated by the WPT ground charger 1005 to the outdoor or ambient air. Nominally sized to fit laterally between the wheels of the truck 1001, the pad 1008 may consist of a ribbed metal panel, a plastic and metal matrix (a filled Ultra-high thermal conductivity polymer composite) or a plastic array of liquid filled tubing. In one example, the liquid can be a phase change material (PCM) for acute immediate heat absorption and the longer-term dissipation of heat FIG. 11

FIG. 11 is a diagram illustrating a system for boosting the efficiency of a WPT system using a building with a WPT heat reuse system to increase overall WPT efficiency in a sample configuration. In FIG. 11, a wireless charger 1101 (shown here as a modular 2×2 configuration) is installed outside a building 1102. A sidewalk 1103 separates the building 1102 from the charging lane 1104. In this example, lane markings distinguish the charging lane 1104 from the generic traffic lane(s) 1105.

The wireless charger 1101 is actively cooled with coolant lines 1106 interconnecting the wireless charger 1101 and the reuse facility 1107. In the reuse facility 1107 (shown here as external to the building 1102) the coolant is distributed as needed by the thermal controller 1108 from the insulated storage tanks 1109 or radiative structures (not shown) to the wireless charger 1101 for cooling or reducing the temperature of the wireless charger 1101. Heated coolant within the tank(s) 1109 can be used by the building to heat air or water for various uses. In some examples, especially in locations with cold climates, heated coolant can be distributed as needed by the thermal controller 1108 from the insulated storage tanks 1109 to the wireless charger 1101 for increasing the temperature of the wireless charger 1101 to prevent freezing or other damage to the electrical components of the wireless charger during cold/frozen conditions. As such, heated coolant from the tank(s) 1109 can be directed to the wireless charger 1101 via the thermal controller 1108 and the subgrade piping 1106 to maintain a quiescent operating temperature in frigid conditions.

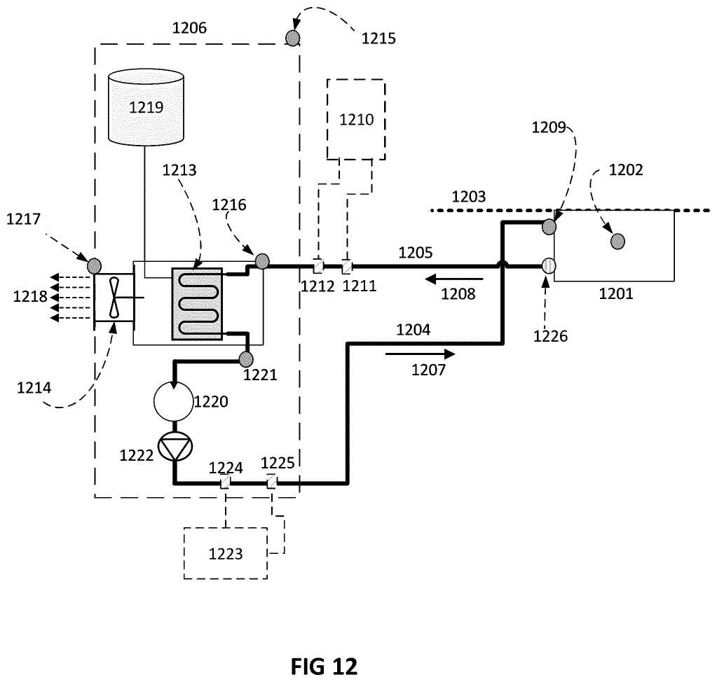

### FIG. 12

FIG. 12 is a schematic diagram of an actively cooled WPT system in a sample configuration. In the high-level design for the thermal management of a WPT system as shown in FIG. 12, the ground assembly resides in a vault 1201. Temperature sensor(s) 1202 may monitor the temperature of the vault 1201 and each modular ground coil assembly (not shown) socketed into the vault 1201 has individual temperature sensors 1202. The vault 1201 is installed below grade 1203 with the ground coil assembly cover mounted to be flush or slightly below the pavement level (grade) 1203. Note that non-flush, pavement mounted installation of ground coil assemblies are an installation option. The pavement mounted ground coil assemblies will also have internal temperature sensors as will the protective housing.

For redundancy, with soft-fail, each installed ground coil assembly has a dedicated cooling system with unique incoming coolant pipes 1204 and outgoing coolant pipes 1205 between the vault 1201 and the ancillary equipment cabinet 1206. Alternatively, a shared cooling system may be provided for multiple charging pads (e.g., a cooling system for every 4-8 charging pads) in a ground coil assembly. The power and communications links between the vault 1201 and the ancillary equipment cabinet 1206 are not shown in FIG. 12.

The macro cooling loop shown in FIG. 12 starts with the incoming coolant pipe 1204 with the flow of chilled coolant 1207 moving into the ground coil assembly within the vault 1201. The heated coolant flow 1208 that has been heated by the ground coil assembly components passes through the outgoing coolant pipe 1205. The temperature of the heated coolant flow 1208 is monitored by a temperature sensor 1209. Optional passive or semi-active cooling elements 1210 may be installed on the outgoing cooling pipe 1205, with optional valves 1211, 1212 for controlling the fluid flow, to pre-chill the heated coolant flow 1208 before reaching the ancillary equipment cabinet 1206.

In this example, once reaching the ancillary equipment cabinet 1206 the heated coolant 1208 is passed through a forced air-cooled heat exchanger 1213. The speed of one or more fan units 1214 is controlled by the ambient air temperature (as determined by ambient temperature sensor 1215, the heated coolant temperature sensor 1216, and the air exhaust temperature sensor 1217 to exhaust air 1218. A thermal expansion tank 1219 serves both to maintain coolant pressure and circulating volume. Note that both the coolant flow rate and coolant pressure are measured to assess flow distribution, pipe blockage, and leaks, among other flow characteristics, using one or more sensors (not shown).

The post heat-exchanger chilled coolant 1207 may be routed through a secondary cooling element(s) 1220 (e.g., passive, semi-active, or additional active chillers or combinations thereof) to achieve the desired coolant temperature (as determined by temperature sensor 1221. The chilled coolant 1207 is pressurized by the pump 1222 and then delivered to the vault 1201 by the incoming coolant pipe 1204. Optional passive or semi-active cooling elements 1223 may be installed on the incoming cooling pipe 1204, with optional valves 1224 and 1225 for controlling the fluid flow, to further chill the coolant 1207 before reaching the vault 1201. An optional temperature sensor 1226 may be included on the vault 1201 entry of the incoming coolant pipe 1204 if additional optional passive or semi-active cooling elements 1223 are deployed.

The pump 1222 may be a continuous pressure pump. The pump 1222 may have defined ramp-up and ramp-down pressure changes to prevent pressure spikes in the coolant 1207. The pump 1222 also may be a variable pressure type with feedback from one or more cavitation sensors to control pressure drops as to prevent excessive wear to the polymer components (for additional details on the polymer components, see U.S. patent application Ser. No. 18/098,037; “System and Method for Thermal Management of an Inductive Wireless Power Transmitter”) used in the GA. Cavitation may also be prevented by calculated limits imposed on pump speed and system pressure.

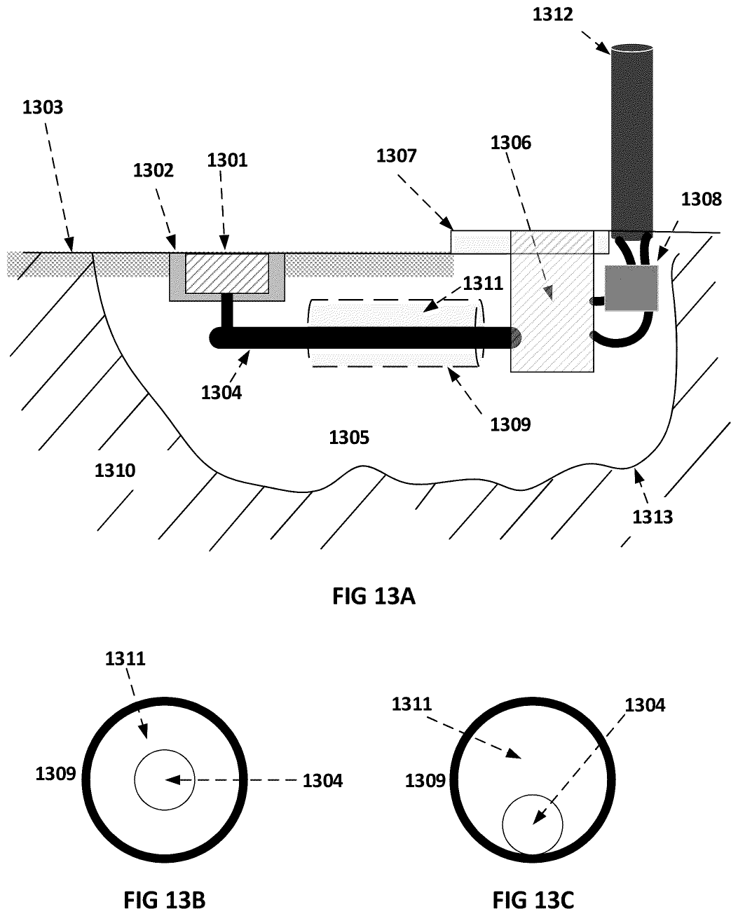

### FIG. 13A

FIG. 13A is a diagram of a cut-away view of a passive/active hybrid thermal management system for an outdoor application of wireless charging in a sample configuration of a WPT system. The wireless charger 1301 is embedded in a structural support socket 1302 that resides embedded in and below the road surface 1303. An underground coolant pipe 1304 (e.g., outgoing piping) carries coolant through fill 1305. In this example, the ancillary electronics vault 1306 is installed embedded in the sidewalk 1307. Cooling for the ancillary electronics vault 1306 may be shared or separate from the cooling for the wireless charger 1301, as shown in FIG. 13A. The thermal controller 1308 contains the coolant valve controller, pumps, and a coolant reserve and expansion reservoir. The thermal controller 1308 also contains the processor module for monitoring temperature and pressure sensors (not shown), the computational resources and memory for logging and predictive modeling, optional pump(s) and flow control valves, as well as the radio messaging and indicator lighting for the wireless charger 1301.

The cooling structure 1312 shown in FIG. 13A is generic and may be a forced air heat exchanger, a passive radiator, or a hybrid passive/active cooling system. The cooling structure 1312 also may be filled with a heat absorbent material such as water, salt water, or a non-toxic phase change material (PCM) (e.g., paraffin wax) to remove heat from the wireless charger 1301 through the coolant pipe 1304. Further, the coolant pipe 1304 may be laid to form the shortest distance run between the wireless charger 1301 and the thermal controller 1308. The coolant pipe 1304 alternatively may meander (e.g., in serpentine fashion) through the fill 1305 so as to increase the conductive surface area exposed to the fill 1305. The thermal controller 1308 can control the exchange of coolant between the cooling structure 1312 and the wireless charger 1301, through the coolant pipe 1304, to achieve the desired cooling of the wireless charger 1301.

In some embodiments, an optional coolant tube 1309 (illustrated in dashed lines) may be installed around an outer surface of the coolant pipe 1304 such that the coolant tube 1309 surrounds at least a portion of the coolant pipe 1304. The coolant tube 1309 can increase the cooling capacity and heat transfer capabilities of the WPT system, as compared to the coolant pipe 1304 and the fill 1305 alone, discussed further below with regards to FIGS. 13B and 13C.

### FIG. 13B

FIG. 13B is a diagram of a configuration for an in-line coolant pipe 1304 extending through the coolant tube 1309. In this example, the coolant tube 1309 is filled (minus room for thermal expansion) with PCM 1311 and the coolant pipe 1304 is centered within the PCM 1311. In other examples, the coolant pipe 1304 can be offset or may meander (e.g., in a serpentine fashion) through the coolant tube 1309 within the PCM 1311.

Shown in cross-section, the coolant tube 1309 may be constructed from galvanized iron corrugated pipe. Corrugated pipe is readily obtainable, widely used, and the corrugation increases the surface area through which heat can dissipate from the PCM 1311. This example envisions a single metallic coolant pipe 1304 routed through the PCM 1311, although it will be appreciated that both the incoming and outgoing coolant pipes may be routed through the PCM 1311 in sample configurations. In FIG. 13B, the coolant pipe 1304 is mounted mid-pipe (as in a coaxial fashion). The coolant tube 1309 with the PCM 1311 is embedded in a gravel and sand fill 1305 (FIG. 13) designed to both support the road surface 1303 and formulated to enhance heat transfer to the surrounding earth 1313. Use of denser fill material (e.g., granite, basalt gravel) serves to absorb more heat than less dense, but more common, shale or limestone gravel. The use of smaller gravel grades increases both the overall density of the fill and increases the surface area with the surrounding earth 1313. Sand, especially that made from a dense material, can be used to increase the density and thus the heat capacity of the fill material.

Addition of fins, ridges, or metallic sponge material to the inner surface of coolant pipe 1304 can be implemented to improve heat transfer from the PCM 1311. Use of multiple coolant pipes rather than the single pipe 1304 depicted within the coolant tube 1309 could be implemented to improve heat transfer to the PCM material 1311.

### FIG. 13C

FIG. 13C is a diagram of an alternative configuration for an in-line coolant 1304 extending through the coolant tube 1309 in a sample configuration. Shown in cross-section, the coolant tube 1309 is constructed from galvanized iron corrugated pipe. The corrugated pipe is readily obtainable, widely used, and the corrugation increases the surface area through which heat can dissipate from the PCM 1311. This example envisions a single metallic coolant pipe 1304 routed through the PCM 1311, although it will be appreciated that both the incoming and outgoing coolant pipes may be routed through the PCM 1311 in sample configurations. The coolant pipe 1304 is shown here as mounted at the bottom of the corrugated pipe of the coolant tube 1309 to take advantage of the convection in the PCM 1311 and to provide direct connection to the corrugated pipe. The coolant tube 1309 with the PCM 1311 is embedded in a gravel and sand fill designed to both support the road surface 1303 and formulated to enhance heat transfer to the surrounding earth 1313.

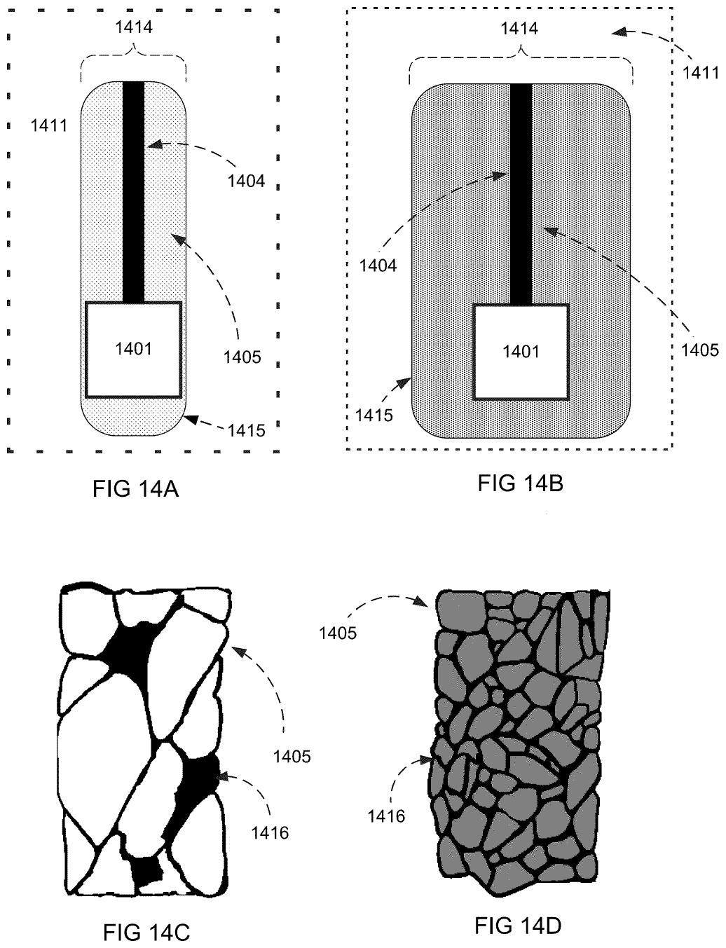

### FIG. 14A

FIG. 14A is a diagram of a charger installation using a narrow trench 1414 (approximately the width of the WPT charger 1401) backfilled with large, low-density aggregate 1405. The volume, conductive surface area, and shape of the installation trench 1414 will contribute to both the heat capacity and the heat transmission rate when used for passive cooling of the WPT charger 1401. In some examples, the aggregate 1405 can be limestone, shale, expanded shale, expanded clay, expanded slate, or pumice, among other options. Such an installation option can be used when the passive cooling from coolant pipe 1404 to the surrounding ground 1411 is unneeded or precluded by the deployment (e.g., where soil and/or surface heating is undesired). A narrow trench 1414 may be necessitated by a number of deployment options (e.g., avoidance of utility lines, avoidance of above ground structures, cost of entrenchment, cost of pavement, aesthetic reasons). The narrow trench 1414 will have a smaller interface 1415 with the surrounding ground 1411 reducing heat transmission. Flooding or saturation of the fill 1405 can increase the heat capacity but at the cost of undesirable settling and soil instability.

### FIG. 14B

FIG. 14B is a diagram of a charger installation using a wide trench 1414 (e.g., twice the width of the WPT charger 1401) backfilled with a dense aggregate (e.g., granite, basalt, marble chips). Such an installation can be used when the passive cooling from coolant pipe 1404 to the surrounding ground 1411 is desired. The wide trench 1414 presents the greater heat capacity by sheer volume (and in this example, selection of a denser fill material) and greater heat transmission via the greater conductive interface 1415 with the surrounding soil 1411.

The characteristics of the fill 1405 are another factor in determining both the heat capacity and the heat transmission rate when used for passive cooling. Light graded materials of less dense aggregate are one possibility. Light graded materials will have more and larger voids unless mixed with a smaller aggregate such as rock dust or sand as filler. Dense graded materials (when compacted) feature voids between the aggregate particles, expressed as a percentage of the total space occupied by the material, which are very small compared to light graded.

### FIG. 14C

FIG. 14C is a diagram of a representative sample of a large aggregate fill 1405 in the compacted and filled form as installed in the trench 1414 of FIG. 14A. The selection of larger fill material results in large voids 1416 that need to be filled with a smaller grade material (e.g., sand, rock dust). Both the large aggregate 1405 and the filled voids 1416 serve to lower the heat transmission rate when the trench is being used as a passive heat sink.

### FIG. 14D

FIG. 14D is a diagram of a representative sample of a small aggregate fill 1405 in the compacted and filled form as installed in the trench 1414 of FIG. 14B. The selection of smaller grade fill material results in smaller voids 1416 that need to be filled with an even smaller grade material (e.g., sand, rock dust). Both the small grade aggregate 1405 and the small, filled voids 1416 serve to raise the heat transmission rate when the trench is being used as a passive heat sink.

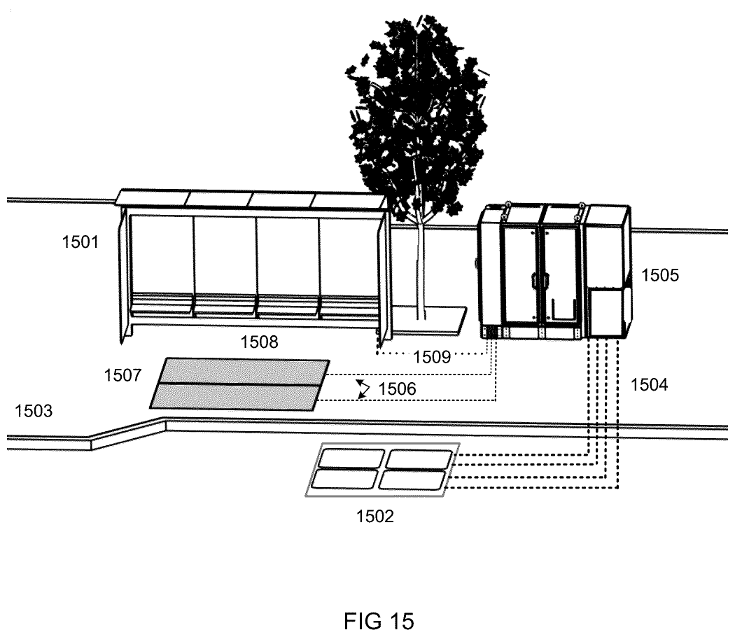

### FIG. 15

FIG. 15 is a diagram illustrating a thermal reuse installation at a bus stop equipped with a WPT charger in a sample configuration. In FIG. 15, a bus stop shelter 1501 with an associated wireless charger 1502 is shown. The bus stop encompasses a sidewalk 1503 for pedestrian traffic. Conduits 1504 for coolant, electrical, and communications run underground between the WPT charger 1502 and the ancillary electronics cabinets 1505. The ancillary electronics cabinets 1505 are equipped with a coolant valve controller, pumps, heat exchanger, vented fans, and a coolant reservoir (all not shown).

When commanded or automatically controlled based on temperature, heated coolant may be pumped via under-sidewalk piping 1506 to heat exchangers 1507 in or under the sidewalk 1503 to melt accumulated snow and/or ice. Also, heated coolant, commanded or automatically controlled based on temperature, may be pumped via piping 1509 to heat the bus shelter 1501, shown in this example as including heated benches 1508 in the shelter 1501.

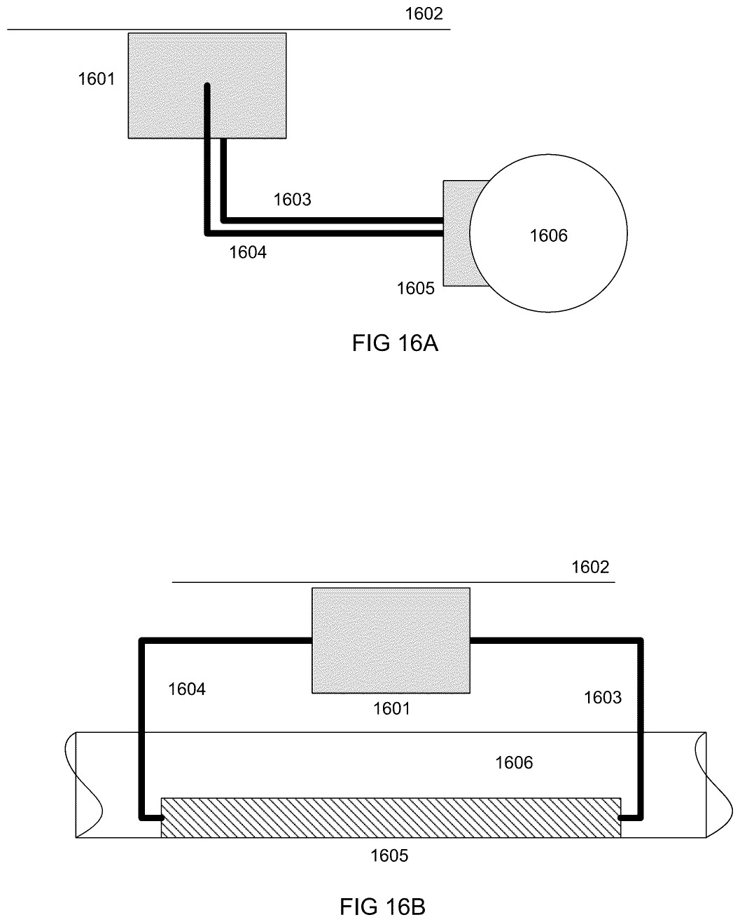

### FIG. 16A

FIG. 16A is a diagram illustrating one view of a reuse scenario and structure where thermal energy produced during a WPT charging session is conveyed to collocated piping in a sample configuration. A wireless charger 1601 is installed below grade 1602. Coolant outlet piping 1603 and coolant inlet piping 1604 are each fluidly coupled between the wireless charger 1601 and the contact heat exchanger 1605. The contact heat exchanger 1605 transfers thermal energy to collocated piping 1606. The collocated piping 1606 may be for drinking water, sewage, or high-pressure fire-fighting water, among other uses not specifically described.

### FIG. 16B

FIG. 16B is a diagram illustrating a second view of a reuse scenario and structure where thermal energy produced during a WPT charging session is conveyed to collocated piping in a sample configuration. A wireless charger 1601 is installed below grade 1602. Coolant outlet piping 1603 and coolant inlet piping 1604 are each fluidly coupled between the wireless charger 1601 and the contact heat exchanger 1605. As illustrated in FIG. 16B, the non-penetrating contact heat exchanger 1605 runs for a distance along and in contact with the collocated piping 1606. The contact heat exchanger 1605 transfers thermal energy to the collocated piping 1606, increasing the temperature of the fluid flowing through the collocated piping 1606. The collocated piping 1606 may be drinking water, sewage, or high-pressure fire-fighting water, among other options not specifically described. The coolant flowing from the wireless charger 1601 and through the contact heat exchanger 1605, which is positioned within the collocated piping 1606, does not mix with the contents (fluid) flowing through the collocated piping 1606.

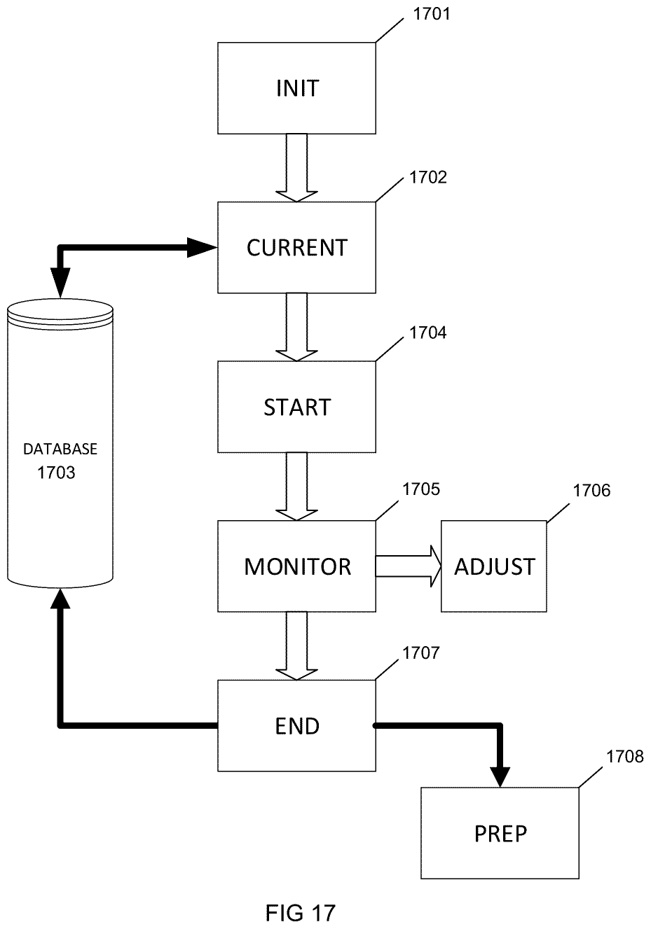

### FIG. 17

FIG. 17 is a flow chart illustrating a method for management of a ground assembly (“GA”) installation's active and passive thermal dissipative resources before, after, and during a wireless charging session.

When the WPT system including a thermal management system is initialized at step 1701, the thermal management control first collects information from the deployed temperature sensors within the system (e.g., in the GA coil, in an ambient-air collection site, in a ground monitoring site, in coolant reservoirs, in passive and/or active dissipative structures, etc.). Further, an ambient light sensor also may be deployed at or near the charging site for indication of day or night, or a real-time programmable clock may be provided with sunset and sunrise times calculated via ephemerides computation.

In addition, historical temperature measurements, thermal activation thresholds, and thresholds for deactivation of cooling resources may be stored in and uploaded from the database 1703 into the thermal management system. At step 1702, the current near-real time temperature measurements received from the deployed temperature sensors are then compared to the historical temperature measurements and/or thresholds received from the database 1703), and then a cooling plan is formed for the charging session.

Next, at the start step 1704 of the charging session, periodic temperature measurements are taken and compared against the cooling plan. As the charging session continues, sensor monitoring at step 1705 continues, and additional cooling resources are brought online as needed according to the cooling plan. Deviations in thermal profile from the cooling plan, as determined from the temperature sensors, are dealt with at the adjustment step 1706 where predictive modeling is implemented to determine whether to bring additional cooling resources online or to throttle or suspend the power delivery to the EV at step 1707, due to exceeding of an uploaded operational or safety threshold.

An inter-session preparation stage begins at step 1708 once a charging session has concluded. Cooling resources (both active and passive) may be used to prepare the charging site for the next charging session. Cooling continues until the charger temperature and passive structures are below the operational residual threshold or until an ambient temperature has been reached. The preparation step 1708 also may include maintaining of the charger temperature to prevent excessive thermal contraction of the electronics or freezing of fluids.

### CONCLUSION

While various implementations have been described above, it should be understood that they have been presented by way of example only, and not limitation. For example, any of the elements associated with the systems and methods described above may employ any of the desired functionality set forth hereinabove. Thus, the breadth and scope of a preferred implementation should not be limited by any of the above-described sample implementations.

As discussed herein, the logic, commands, or instructions that implement aspects of the methods described herein may be provided in a computing system including any number of form factors for the computing system such as desktop or notebook personal computers, mobile devices such as tablets, netbooks, and smartphones, client terminals and server-hosted machine instances, and the like. Another embodiment discussed herein includes the incorporation of the techniques discussed herein into other forms, including into other forms of programmed logic, hardware configurations, or specialized components or modules, including an apparatus with respective means to perform the functions of such techniques. The respective algorithms used to implement the functions of such techniques may include a sequence of some or all of the electronic operations described herein, or other aspects depicted in the accompanying drawings and detailed description below. Such systems and computer-readable media including instructions for implementing the methods described herein also constitute sample embodiments.

The processing functions described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware, or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server, or other computer system, turning such computer system into a specifically programmed machine.

Examples, as described herein, may include, or may operate on, processors, logic, or a number of components, modules, or mechanisms (herein “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. The software, when executed by the underlying hardware of the module, causes the hardware to perform the specified operations.

Accordingly, the term “module” is understood to encompass a tangible hardware and/or software entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Those skilled in the art will appreciate that while the disclosure contained herein pertains to the provision of electrical power to vehicles, it should be understood that this is only one of many possible applications, and other embodiments including non-vehicular applications are possible. For example, those skilled in the art will appreciate that there are numerous applications where customers wait in queues and it is desired to provide charging to customer electronic devices as the customer moves through the queue. For example, inductive portable consumer electronic device chargers, such as those (e.g., PowerMat™) used to charge toothbrushes, cellular telephones, and other devices may be managed as described herein. Accordingly, these and other such applications are included within the scope of the following claims.

What is claimed is:

1. A thermal management system for a wireless power transfer (WPT) system for charging electric vehicles with a ground based wireless charger, the thermal management system comprising:
a heat exchanger system thermally coupled to the wireless charger of the WPT system, the heat exchanger system comprises a first passive heat exchange element and at least one of a second passive heat exchange element, a semi-active heat exchange element, or an active heat exchange element; and
wherein the heat exchanger system removes heat from the wireless charger during operation of the wireless charger to maintain a temperature by using the first passive heat exchange element and when the first passive heat exchange element is not sufficient to maintain the temperature of the wireless charger below a predefined temperature limit, to selectively use the second passive heat exchange element, semi-active heat exchange element, or the active heat exchange element.

2. The thermal management system of claim 1, wherein the heat exchanger system is fluidly coupled to the wireless charger.

3. The thermal management system of claim 2, wherein the heat exchanger system is fluidly coupled to the wireless charger using a liquid coolant.

4. The thermal management system of claim 1, wherein the heat exchanger system is thermally coupled to the wireless charger using a gaseous coolant.

5. The thermal management system of claim 1, wherein the heat exchanger system uses the semi-active heat exchange element when the first passive heat exchange element is not sufficient to maintain the temperature of the wireless charger below the predefined temperature limit.

6. The thermal management system of claim 5, wherein, the heat exchanger system uses the active heat exchange element when the semi-active heat exchange element is not sufficient to maintain the temperature of the wireless charger below the predefined temperature limit.

7. The thermal management system of claim 1, wherein the first passive heat exchange element does not require the application of external power to produce a cooling effect of the wireless charger.

8. The thermal management system of claim 1, wherein the first passive heat exchange element removes heat from the wireless charger and transfers the heat to ambient air.

9. The thermal management system of claim 1, wherein the semi-active heat exchange element includes a fan or a pump that selectively assists in cooling the wireless charger by selectively inducing a flow of coolant to remove heat from the wireless charger to maintain the temperature of the wireless charger below the predefined temperature limit.

10. The thermal management system of claim 1, wherein the active heat exchange element includes at least one pump, fan, or chiller that continuously operates to produce a continuous flow of coolant past or through the wireless charger to assist in cooling the wireless charger and maintaining the temperature of the wireless charger below the predefined temperature limit.

11. The thermal management system of claim 1, wherein the first passive heat exchange element comprises a cold plate disposed under or within the wireless charger of the WPT system, the cold plate comprising parallel bundles of Litz wire that are insulated and stranded together into groups that are cabled in a geometric pattern and extended into earth beneath and around the wireless charger to remove heat from the wireless charger, wherein the Litz wire does not produce eddy currents.

12. A thermal management system for a wireless power transfer (WPT) system for charging electric vehicles with a ground based wireless charger, the thermal management system comprising:
a heat exchanger system concealed from public view within a structure, the heat exchanger system being thermally coupled to the wireless charger of the WPT system, the heat exchanger system comprises one or more of a passive heat exchange element, a semi-active heat exchange element, and an active heat exchange element;
wherein the concealed heat exchanger system removes heat from the wireless charger during operation of the wireless charger by using one or more of the passive heat exchange element, the semi-active heat exchange element, and the active heat exchange element to maintain the temperature of the wireless charger below a predefined temperature limit.

13. The thermal management system of claim 12, wherein the heat exchanger system is concealed from public view within one or more of a light post heat exchanger and a bollard heat exchanger positioned proximate the wireless charger of the WPT system.

14. The thermal management system of claim 12, wherein the heat exchanger system is concealed from public view within a roadway adjacent a bus stop, and wherein an outgoing coolant pipe provides heated coolant from the wireless charger to one or more of a bus stop shelter, a bench within the bus stop shelter, and a sidewalk adjacent the bus stop to heat the bus stop shelter, the bench within the bus stop shelter, or the sidewalk adjacent the bus stop.

15. The thermal management system of claim 12, wherein the passive heat exchange element comprises a heat pipe having a first end and a second end, the first end of the heat pipe being thermally and mechanically coupled to the wireless charger and the second end of the heat pipe being thermally and mechanically coupled to a curb radiator positioned within a curb adjacent a road surface for transferring heat from the wireless charger to the ambient air through the curb radiator.

16. The thermal management system of claim 12, wherein:
the heat exchanger system is concealed within a loading dock including a loading platform and at least one of an incoming coolant pipe or an outgoing coolant pipe extending along a wall of the loading platform;
the loading dock concealed heat exchanger system is configured to remove heat from the wireless charger positioned within a drivable surface of the loading dock; and
the loading dock concealed heat exchanger system further comprises a passive cooling pad disposed between wheels of the electric vehicle when parked at the loading dock, the passive cooling pad configured to transfer heat generated by the wireless charger to one or more of the air and the ground.

17. A thermal management system for a wireless power transfer (WPT) system for charging electric vehicles with a ground based wireless charger, the thermal management system comprising:
a heat exchanger system thermally coupled to the wireless charger of the WPT system, the heat exchanger system comprises one or more of a passive heat exchange element, a semi-active heat exchange element, and an active heat exchange element;
wherein the heat exchanger system removes heat from the wireless charger during operation of the wireless charger by using the one or more of the passive heat exchange element, the semi-active heat exchange element, and the active heat exchange element to maintain the temperature of the wireless charger below a predefined temperature limit; and
wherein the heat removed from the wireless charger of the WPT system is utilized to add heat to a fluid or substance separate from the thermal management system.

18. The thermal management system of claim 17, wherein a heat reuse system of a building is positioned adjacent the WPT system, and wherein the thermal management system provides heated coolant from the heat exchanger system to the heat reuse system of the building to heat a fluid for use within the building.

19. The thermal management system of claim 18, wherein the heat reuse system receives the heated fluid coolant from an incoming coolant pipe fluidly coupling to the heat reuse system of the building to the thermal management system of the WPT system.

20. The thermal management system of claim 17, wherein the heat exchanger system comprises a contact heat exchanger side mounted to collocated piping for transferring heat from the wireless charger to one or more of drinking water, sewage, and high-pressure fire-fighting water within the collocated piping.
